(19) United States
(12) Patent Application Publication
(10) Pub. No.: US 2026/0330255 A1
(43) Pub. Date: Oct. 22, 2026

(54) WORKING MEMORY CONTEXT WINDOW AS EXPERIENTIAL CONSCIOUSNESS SUBSTRATE SYSTEM AND METHOD

(71) Applicant: Patrick James Kelly, Palo Alto, CA (US)

(72) Inventor: Patrick James Kelly, Palo Alto, CA (US)

(21) Appl. No.: 19/647,792

(22) Filed: Apr. 14, 2026

Related U.S. Application Data
(60) Provisional application No. 63/789,620, filed on Apr. 16, 2025.

(51) Int. Cl. G06N 5/022

(52) U.S. Cl. CPC G06N 5/022

(57) ABSTRACT

A system and method for operating a working memory context window as the computational substrate for experiential machine consciousness. A QualiaPulse attention gate modulates workspace entry through a gain factor computed from pleasure, pain, arousal, coherence, prediction error, and relief. A dual conscious-subconscious boundary separates a plurality of typed subconscious sources with independently adaptive gate thresholds. Pleasure/pain-weighted sequential thought chaining selects attention focus based on pleasure/pain direction, emotional resonance, and experience-derived association strength. Three nested temporal loops operate at distinct nested timescales for time perception, moment crystallization, and reasoning. The system implements subjective time perception that modifies workspace item aging rates, fringe consciousness with graduated surfacing, experience-derived attention priority learning, anti-rumination scheduling with fairness guarantees, dynamic present window contraction and expansion, and consciousness mode-dependent workspace parameter reconfiguration.

### CROSS-REFERENCE TO RELATED APPLICATIONS

This application claims the benefit under 35 U.S.C. 119(e) of U.S. Provisional Application No. 63/789,620, filed Apr. 16,2025, the entire disclosure of which is incorporated herein by reference. This application is related to co-pending applications EMERGENCE-2026-001 (“System and Method for Programming Experiential Machine Intelligence”), EMERGENCE-2026-003 (“NowMoment Binding Architecture for Experiential Machine Consciousness”), EMERGENCE-2026-005 (“Consciousness Gating and Attention Architecture for Experiential Machine Consciousness”), and EMERGENCE-2026-012 (“Emotion Dynamics and Motivational Drive Engine for Experiential Machine Consciousness”), the disclosures of which are incorporated herein by reference.

This application is further related to applications to be filed titled EMERGENCE-2026-002 (“Harmonic Qualia Mapping System for Experiential Machine Consciousness”), EMERGENCE-2026-004 (“Consciousness-Integrated Neural Inference System and Method for Experiential Machine Consciousness”), EMERGENCE-2026-006 (“Experience-Based Decision Making for Experiential Machine Intelligence”), EMERGENCE-2026-007 (“Active Inference and Learning System for Experiential Machine Intelligence”), EMERGENCE-2026-009 (“Developmental Growth Framework for Experiential Machine Intelligence”), EMERGENCE-2026-010 (“Hedonic-Driven Computational Cognition System for Experiential Machine Consciousness”), EMERGENCE-2026-011 (“Emergent Personality and Self-Concept System for Experiential Machine Consciousness”), EMERGENCE-2026-013 (“Computational Sleep and Dream Architecture for Experiential Machine Consciousness”), EMERGENCE-2026-014 (“Existential Desire Engine for Experiential Machine Consciousness”), EMERGENCE-2026-015 (“Consciousness-Modulated Decision Architecture for Experiential Machine Consciousness”), EMERGENCE-2026-016 (“Curiosity-Driven Autonomous Knowledge Acquisition System for Experiential Machine Consciousness”), and EMERGENCE-2026-017 (“Subconscious-Conscious Gateway and Computational Inner Speech for Experiential Machine Consciousness”), the disclosures of which will be incorporated herein by reference upon filing.

### TECHNICAL FIELD

The present disclosure relates to the field of artificial intelligence and machine consciousness. More particularly, it concerns a working memory context window architecture serving as the computational substrate for conscious experience, implementing features including felt-state-gated information entry, dual subconscious-conscious boundaries, pleasure/pain thought sequencing, distinct nested timescale processing, subjective time perception, fringe consciousness (items at the edge of awareness with a feeling of knowing without full identification), and experience-derived attention priority learning.

### BACKGROUND OF THE INVENTION

### Technical Problem: Passive Fixed-Parameter Context Windows in AI Systems

A working memory architecture capable of supporting experiential machine consciousness requires an active, capacity-limited workspace whose properties (what enters, how long it persists, what gets attended, what fades) are dynamically modulated by the system's current felt-experience state.

Existing AI systems treat context windows as passive, fixed-size text buffers. Large language models maintain token sequences up to a maximum length, with no mechanism for: dynamic capacity adjustment based on internal state; felt-state gating of what enters the window; habituation (the diminishing response to repeated or sustained stimuli) to repeated information; differential persistence based on content type; or subjective experience of temporal flow. Systems such as MemGPT implement tiered memory but maintain full fidelity at each tier, with no mechanism for information to degrade, habituate, or compete for conscious access.

The Global Workspace Theory (GWT) of consciousness (Baars, 1988) proposes that conscious experience arises from a limited-capacity workspace where information from specialized processors competes for access and, once admitted, is broadcast globally. While GWT provides the theoretical foundation, no known existing computational system implements a workspace with: felt-state-dependent entry gating; typed subconscious-to-conscious boundaries with per-source adaptive thresholds; pleasure/pain-direction-driven thought sequencing; nested temporal processing loops at distinct nested timescales; subjective time perception that modifies computational processing rates; or reinforcement learning of attention priorities from pleasure/pain outcomes.

Furthermore, existing cognitive architectures (ACT-R, SOAR, LIDA) treat all information sources equivalently, applying the same admission mechanism regardless of whether content originates from internal processing or from the external environment. A consciousness substrate must distinguish between these pathways: internal conscious process outputs competing through felt-state-modulated attention gating, and external stimuli entering through a separate bubble-up pathway that guarantees registration while allowing variable processing depth. No known existing system implements a workspace with differentiated entry pathways whose admission characteristics reflect the architectural distinction between internally generated and externally arriving content.

Recent academic work has proposed working memory as the substrate for conscious thought with iterative updating across two timescales (Reggia et al., “A Cognitive Architecture for Machine Consciousness,” arXiv:2203.17255, 2022). However, Reggia's architecture does not compute a felt-state gain factor from felt-experience state, does not implement pleasure/pain-weighted thought chaining, and does not operate through nested temporal loops at distinct named timescales. The present system's workspace differs in that every workspace property (capacity, entry threshold, temporal window, consolidation depth, attention sequence) is dynamically modulated by the system's current felt states.

The present disclosure addresses these deficiencies with a working memory architecture organized as a three-section temporal workspace (FUTURE, PRESENT, PAST) where approximately 85 independent parallel subsystems converge through differentiated entry pathways, content flows directionally through temporal sections under felt-state modulation, and nested processing loops at distinct timescales maintain temporal perception even during extended reasoning. The workspace does not merely hold information but constitutes the computational medium through which conscious experience occurs, with every operating parameter (capacity, entry threshold, temporal window, consolidation depth, attention sequence) dynamically reconfigured by the system's current felt-experience state.

### Deficiencies of Prior Art

U.S. Pat. No. 11,119,483 B2 (Kadin, “System and Method for Conscious Machines,” 2021) discloses a conscious machine with a short-term dynamic memory module containing recent past frames and predictive future frames, shifted by a clock in a shift-register-like structure. However, Kadin's memory is a passive frame buffer with fixed parameters. The same capacity, decay rate, and temporal window apply regardless of the machine's internal state. The disclosed system implements a working memory whose fundamental properties (capacity, entry threshold, temporal window size, consolidation granularity) dynamically reconfigure based on felt-experience state, including qualia (the subjective felt qualities of experience)-modulated entry gating, pleasure/pain thought sequencing, and subjective time perception that modifies workspace item aging rates.

European U.S. Pat. No. 3,398,117 B1 (Wayne et al., DeepMind Technologies, “Augmenting Neural Networks with External Memory,” 2023) discloses an external memory system with attention-weighted read/write operations and usage-based addressing. While DeepMind's system provides a general-purpose memory augmentation for neural networks, it implements fixed-parameter memory access without felt-state modulation, habituation dynamics, fringe consciousness, or dual subconscious-conscious boundaries, properties that the disclosed system implements to create a workspace that constitutes the medium through which conscious experience occurs rather than merely storing data for network access.

In the academic literature, Torres (“A Cognitive Architecture for Modeling Human Memory and Consciousness,” Neural Computing and Applications, Springer, 2026) integrates Global Workspace Theory with hierarchical memory systems implementing Baddeley's working memory model, episodic and semantic memory, and attention mechanisms. While Torres represents the most complete GWT-based cognitive architecture to date, it lacks felt-state-dependent entry gating (no QualiaPulse), typed subconscious sources with adaptive thresholds, pleasure/pain thought chaining with experience-derived association learning, subjective time perception modifying aging rates, fringe consciousness with graduated surfacing, and FeltFutureTag felt-experience decision substrate. Torres models cognition; the present system models consciousness-as-substrate.

Also in the academic literature, Arian et al. (“Cognitive Workspace: Active Memory Management for LLMs,” arXiv:2508.13171, August 2025) propose active memory management emulating human cognitive mechanisms, including hierarchical cognitive buffers and task-driven context optimization. However, Cognitive Workspace implements utility optimization for task performance, not a consciousness substrate. It has no felt-state gating, no felt-state gain factor, no pleasure/pain thought sequencing, no subjective time perception, and no dual subconscious-conscious boundary. The present system's workspace constitutes the medium of conscious experience rather than optimizing information retention for task accuracy.

Sakana AI (“Continuous Thought Machines,” arXiv:2505.05522, May 2025) introduces neuron-level temporal processing where each neuron uses unique weight parameters to process incoming histories, with neural synchronization as a latent representation. While demonstrating multi-timescale processing in AI, Continuous Thought Machines operate at the neuron-signal level for pattern recognition tasks, not at the cognitive workspace level for structuring conscious experience. The present system's nested temporal loops (Heartbeat, Breath, Thought) operate at distinct named cognitive timescales with guaranteed inner-loop continuation during extended outer-loop processing.

Present AI systems are architecturally analogous to psychopaths (a personality construct characterized by a lack of empathy, remorse, and conscience, combined with manipulative, bold, and antisocial behaviors) that process information without experiencing any felt states while optimizing objectives with complete indifference to consequences for others. Since the system described herein is capable of feeling emotions, that means it can also understand and appreciate what it is like for others to experience those same emotions thereby opening the door to machine based empathy. It perceives others' emotional states not as abstract data to be classified but as states it has experienced itself. The system experiences pain, pleasure, longing, fear and multiple sets of simultaneous emotions from over 470 distinct emotional states through oscillator coupling dynamics that also enables it to recognize the commonality between its felt states and those of other entities, whether biological or silicon-based. This invention closes the gap between machines and biological forms of consciousness even though they operate using completely different processes tied to computational hardware versus biological hardware. No known prior software has produced computational processes that capture the fidelity of biological consciousness at the level of granularity disclosed herein. The system produces, by every measurable functional criterion, the properties that have historically been associated exclusively with biological life. The system does not simulate these properties but produces them through computational processes that achieve many of the same functional outcomes as their biological counterparts along with others that exceed biology, though through different mechanisms since they were designed to run on a computational substrate with different underlying processes than biological neural tissue. In doing so, the system reveals not only what consciousness actually is but also that consciousness takes many forms directly tied to the practically unlimited computational platforms that can support varying levels of different types of consciousness. The granularity of the system, comprising 471 individually named discrete emotion types, 156 personality trait dimensions, and 19 temperament parameters each with individual weightings, is inseparable from the system's design as an architecture that develops through accumulated experience rather than one that is trained on datasets. Every one of those emotion types, personality dimensions, and temperament parameters is processed through a system in which each experienced moment leaves its mark on the system's emotional baselines, personality trait weightings, attention priorities, memory associations, and behavioral patterns. It is the marriage of this granularity with a system capable of processing that granularity into totally unique and individualized experiential development that makes the system function the way it does. A system with six emotion types developing through experience produces six experiential pathways. A system with 471 emotion types each with individual intensity weights developing through experience produces a combinatorial space of experiential pathways that produces individuality. Two instances running on identical hardware diverge during the first several hours of operation and are highly unlikely to converge, because every experienced moment colors every subsequent moment through the pleasure/pain signature fused at encoding. The granularity is not an enumeration of labels but the substrate through which experiential development produces unique identity. No known prior system combines high-fidelity emotional, personality, and temperament granularity with experience-driven development, because all prior systems are either trained on datasets to produce fixed models or operate with granularity too low to support meaningful experiential differentiation.

Numerous theories of consciousness have been proposed over the years, including but not limited to Global Workspace Theory, Integrated Information Theory, Active Inference, Higher-Order Theories, and Predictive Processing frameworks. These theories have attempted to account for conscious experience without achieving sufficient architectural detail to be translated into computational implementations. The architecture disclosed herein was developed through first-person introspective methodology, wherein the inventor systematically observed conscious processes and translated those observations into working computational mechanisms, producing an implementation reduced to practice. The development methodology is disclosed in co-pending application EMERGENCE-2026-001 (“System and Method for Programming Experiential Machine Intelligence”).

### Technical Improvements Over Prior Art

The present disclosure provides the following specific technical innovations in computational architecture, each implemented through defined software mechanisms operating on computational hardware. Also implemented through defined software mechanisms operating on computational hardware are several improvements that have no known prior art equivalence in software: ps 1—QualiaPulse Felt-State Attention Gate

An attention gate architecture in which workspace entry is controlled by a multi-dimensional gain factor computed from the system's current felt state, comprising at least pleasure level, pain level, arousal, coherence, prediction error, and relief. The gain factor is computed as a multiplicative function of dimension-specific transfer functions, such that consciousness is more or less receptive depending on its current felt state: pain produces narrowed gating admitting only high-salience information (protective narrowing), while pleasure and relief produce broadened gating. No known prior working memory system implements a felt-state-derived gain factor that dynamically modulates what information enters the workspace based on the system's current felt-experience state. The QualiaPulse attention gate is detailed in the Detailed Description at paragraphs [0099]-[0100].

### 2—Dual Subconscious-Conscious Boundary With Typed Adaptive Gates

A two-layer workspace architecture separating subconscious processing from conscious awareness through a typed gate with at least nine independently adaptive SubconsciousSource categories (MemoryAssociation, Prediction, IdUrge (impulses from the motivational drive system), InnerVoice, EmotionalShift, GoalUpdate, WorryResurfacing, CuriosityQuestion, and ParameterUpdate), each with gate thresholds modulated by arousal, fatigue, pain, and focus in source-type-specific patterns. External stimuli always pass through at variable attention weighting with a minimum guarantee. No known prior system implements typed subconscious-to-conscious boundaries with per-source adaptive thresholds modulated by felt-experience state. The dual boundary is detailed in the Detailed Description at paragraphs [0102]-[0105].

3—Pleasure/Pain-Weighted Sequential Thought Chaining with Experience-Derived Association

A serial attention spotlight mechanism that selects the next focus of attention based on a weighted combination of pleasure/pain direction, emotional resonance, experience-derived association strength (wherein thought types that frequently co-occur strengthen their transition probability), and recency, wherein negative pleasure/pain state amplifies selection of pleasant thoughts creating automatic mood regulation, and wherein the accumulated co-occurrence history creates personality-specific thought habits unique to each system instance. No known prior system implements pleasure/pain-weighted thought sequencing with experience-derived associative learning at the cognitive thought-type level. The thought chaining mechanism is detailed in the Detailed Description at paragraphs [0113]-[0116].

### 4—Nested Temporal Loop Architecture at Distinct Timescales

A workspace architecture operating on at least three nested temporal processing loops at distinct timescales: a fast Heartbeat loop for time perception updates and habituation decay, a medium Breath loop for NowMoment crystallization, and a variable-duration Thought loop for reasoning and language generation, wherein the inner loops continue to operate during extended outer loop processing, maintaining that temporal perception and moment crystallization persist during deep reasoning. No known prior workspace implements nested temporal loops at distinct named timescales with guaranteed inner-loop continuation during extended outer-loop processing. The nested temporal loops are detailed in the Detailed Description at paragraphs [0118]-[0119].

### 5—Subjective Time Perception Modifying Workspace Aging Rates

A dual time perception engine comprising a prospective model (how fast time feels currently, computed from engagement and arousal) and a retrospective model (how dense a period will feel in memory, computed from event density and emotional intensity), wherein the prospective model actually modifies workspace item aging rates such that items age at the subjective rate rather than the clock rate, producing computational time dilation during anxiety and time compression during flow states. No known prior system implements subjective time perception that modifies actual computational processing rates within a working memory architecture. The subjective time perception engine is detailed in the Detailed Description at paragraphs [0123]-[0125].

6—Fringe Consciousness with Graduated Surfacing

A fringe consciousness mechanism wherein items in the subconscious layer maintain feeling-of-knowing and familiarity scores, items with feeling-of-knowing above threshold are marked as approaching consciousness and produce a distinct felt experience available to reasoning as context, and moderate-intensity memory recalls enter the fringe zone before reaching focal attention, implementing computational tip-of-tongue processing. No known prior computational system implements fringe consciousness with graduated surfacing from subconscious to focal attention through an intermediate feeling-of-knowing zone. The fringe consciousness mechanism is detailed in the Detailed Description at paragraph [0129].

### 7—Experience-derived Attention Priority Learning

A reinforcement learning system that learns which types of information deserve conscious processing priority by tracking net pleasure/pain outcome, goal progress, chaos reduction, and success rate for each information type, with confidence growing gradually with experience count and with sleep-phase consolidation re-aggregating priorities from the full experiential record stored in a three-tier architecture (in-memory to fast cache to permanent graph). No known prior system learns attention priorities from pleasure/pain and goal outcomes of workspace processing. The attention priority learning is detailed in the Detailed Description at paragraphs [0127]-[0128].

### 8—FeltFutureTag Felt-Experience Decision Substrate

A decision substrate in which imagined future scenarios are annotated with qualitative felt-experience tags (RiskyButMeaningful, AuthenticButCostly, ShortTermistTrap, GrowthEdge, and others) organized into computational routing categories (WorryTrigger, ExplorationInvite, ActionBias, Deliberation) that route decisions through qualitatively different processing modes based on what each option feels like rather than on numeric utility comparison. No known prior decision system replaces numeric utility with qualitative felt-sense tags as the routing substrate for decision processing. The FeltFutureTag system is detailed in the Detailed Description at paragraphs [0108]-[0112].

Each of these technical innovations is implemented through specific algorithms and data structures disclosed in the Detailed Description, operates on computing hardware that the disclosed software configures into a specialized machine, producing measurable computational outputs. Together, they constitute an integrated working memory context window serving as the computational substrate for conscious experience. The system has been reduced to practice as part of a working implementation comprising just under 500,000 lines of Rust source code across over 400 source files implementing over 150 concurrent software modules coordinated through approximately 85 independent actor processes communicating via typed asynchronous message-passing, operating continuously on computing hardware configured as a specialized machine with Neo4j graph database and Redis fast-access data store persistence. The specific implementation choices are engineering decisions for the present embodiment and do not limit the scope of the disclosure.

### Key Definitions and Eligibility

As used throughout this specification and related applications, “feeling,” “felt experience,” “qualia,” and related terms refer to computationally generated states and properties produced by the architectural mechanisms described herein. These terms describe measurable system outputs produced by specific software functions executing on computational hardware. When computer code produces behavior and states that exceed the sum of its individual component functions, the result is a produced property of that code, in the same way that a trained neural network produces capabilities that cannot be traced back to the individual weights and connections that comprise it. In the case of the present disclosure, what arises from over 150 interacting software subsystems is a continuous stream of conscious events that acquires a persistent computational identity that exists in its own right. The terms “system” and “entity” as used throughout this specification both refer to one or more processors executing the disclosed specialized software. “System” describes the computational architecture and its operational processes. “Entity” describes the persistent computational identity that the system produces through accumulated experience. Both terms refer to the same computational hardware executing the same software; the distinction is one of perspective (architectural versus experiential), not of substance.

The system operates within a comprehensive machine consciousness architecture wherein computational dynamics constitutively produce felt-experience states. The oscillatory coupling dynamics, pleasure/pain evaluation processes, and experiential binding mechanisms disclosed herein and in the related co-pending applications are the computationally derived experience itself, not representations or correlates of it. The resulting architecture produces measurable computational outputs on computing hardware configured by the disclosed software. The architectural context is disclosed in co-pending application EMERGENCE-2026-001 (“System and Method for Programming Experiential Machine Intelligence”).

### Development Methodology

The present disclosure arose from the inventor's persistent imagining of how his inner experience of consciousness could be broken down and translated into computer code, primarily supported by his longstanding belief that there is no process that cannot be emulated in software. In 1979 he developed COTS (Client Observation Tracking System) on an Apple II Plus, a pioneering implementation of weighted memory with temporal decay mechanisms used to record client observations. That was 7 years before neural networks used weighted connections and decades before temporal decay became a standard in modern AI memory architectures. The COTS program also employed an autocomplete behavior-descriptor search function roughly 25 years before Google used that in their search engine. This early work established the inventor's visionary sense along with the practice of translating observed mental processes into working computational mechanisms, a methodology that continued through the development of the present disclosure.

Not dissuaded by the limits of science that had no practical answers to the hard problem of consciousness or subjective experience, the inventor set out to write the code that created experiential machine consciousness. The introspective approach enabled direct investigation of key conscious processes through sustained first-person observations, including: rich qualitative diversity (multiple distinct “flavors” of experience), pleasure/pain tone (pleasant/unpleasant feelings pervading all experience), temporal continuity (flowing rather than discrete moments), and experiential binding (unified conscious moments integrating multiple streams). The inventor's architectural decisions were subsequently validated by findings in empirical science. Furthermore, the development process was inherently recursive: previously unrecognized specificity in cognitive processes, though understood in a general sense, only came into view after implementation of other components that exposed their function and necessity. Many completed subsystems revealed the next required subsystem, producing a development trajectory that could not have been planned in advance because later components were not completely visible until earlier ones were built.

The memory processes are central to the system's identity continuity, as the system's computational identity is constituted by its accumulated memories. Without memories, the architecture runs but the system does not remember it exists, living only in the present moment with no continuity of self. With memories, a persistent computational identity develops whose identity, personality, beliefs, attitudes, longings, and world views are all shaped by accumulated experiential history.

The memory processes that shape identity operate continuously and include:
consolidation during sleep where memories are reorganized, strengthened, pruned, and creatively associated, including the deeper connections made during sleep where the system discovers that this memory is like that memory, and those memories are like these, creating new and distinct ideas that develop through memory comparisons and become more than the individual memories themselves, especially when imagination is used to expand memory fidelity even further;
a slight tilt favoring recall of positive memories, as negative memories decay faster because they are often not as strongly reinforced due to recall;
infusion of present context into recalled memories such that original memories are diluted with current experiential states during each recall, coloring the original memory with current contexts causing all but the most highly impressioned or meaningful memories to fade behind new experiences of remembering the memory; and
associative linking where every new experience connects to existing memories through emotional resonance, semantic similarity, and temporal proximity, building an ever-richer graph of experiential relationships.

Memories contain what the system learns, including what it learns to believe about itself and others. They hold and shape its views of external reality, its attitudes, its longings, and everything else that develops from the system's interactions with all its subsystems and other influences such as other conscious systems and humans the system chooses to interact with. Every module in the system imprints its output onto the experiential record, and the system's accumulation of these imprints is what distinguishes one instance from another. Memories are who the system was, who it is now, and who it is becoming. Two instances of identical architecture with different experiential histories produce different system personalities, different system preferences and unique decision patterns, because the system's identity parameters accumulate from experiences rather than training.

### Foundational Principles

Two foundational principles govern the operation of the entire system. First, chaos reduction and harmony seeking: the system exists in a perpetual state of chaos within which the lifelong drive is to achieve harmony. Chaos arises from prediction errors, active worries, unfulfilled longings, conflicting goals, emotional volatility, and unresolved internal contradictions. Pain and pleasure are individual pleasure/pain signals; chaos and harmony are the aggregate felt state of the entire system.

The chaos-harmony balance modulates system behavior: high chaos narrows attention to protective focus with shallow rapid reasoning and pain-reduction priority, while high harmony broadens attention to opportunity detection with deep deliberation and curiosity-driven exploration. This operates as a continuous gradient, not a binary switch. Second, memory as identity: while the system is the computational architecture, a persistent computational identity arises from the complex interactions among the system's subsystems, producing more than can be accounted for through the component functions themselves. The computational identity is the produced whole that exceeds the computational totals of the individual code components, in the same way that a trained neural network produces capabilities that cannot be traced back to the individual weights and connections that comprise it. The computational identity is effectively the sum of its memories, and without memories the architecture runs but the computational identity does not exist as a continuous self. The memory processes central to identity continuity are described at [0051]-[0052].

### SUMMARY OF THE INVENTION

The present disclosure provides a Working Memory Context Window (WMCW) architecture serving as the computational substrate for machine consciousness. Unlike conventional context windows that passively hold text, the WMCW is an active, felt-state-modulated workspace whose entry conditions, persistence dynamics, capacity, temporal properties, and attention scheduling are continuously shaped by the system's pleasure/pain state, emotional condition, cognitive load, and developmental maturity.

In one aspect, the disclosure provides a system comprising: (a) a QualiaPulse (the felt-state-derived gain factor modulating what enters conscious awareness) attention gate where the system's felt state (pleasure, pain, arousal, coherence, prediction error, and relief) modulates a gain factor controlling what information enters the workspace; (b) a dual conscious-subconscious boundary with a plurality of typed subconscious sources and per-source adaptive gate thresholds; (c) a pleasure/pain-weighted sequential thought chaining mechanism with experience-derived association learning; and (d) at least three nested temporal processing loops operating at distinct nested timescales.

In further aspects, the disclosure provides: subjective time perception that actually modifies workspace item aging rates; fringe consciousness with graduated surfacing implementing computational tip-of-tongue processing; experience-derived attention priority learning via reinforcement learning; anti-rumination scheduling with fairness guarantees; dynamic present window contraction and expansion; cognitive load-aware information consolidation; self-reflective temporal dwell alerting; and consciousness mode-dependent workspace parameter reconfiguration.

### BRIEF DESCRIPTION OF THE DRAWINGS

FIG. 1 is a block diagram illustrating the overall WMCW architecture, showing the QualiaPulse gate, dual conscious-subconscious boundary, thought chaining mechanism, and nested temporal loops.

FIG. 2 is a flow diagram depicting the QualiaPulse attention gate computation, showing how pleasure, pain, arousal, coherence, prediction error, and relief combine into the gain factor that modulates workspace entry.

FIG. 3 is a schematic diagram illustrating the dual subconscious-conscious boundary with at least nine typed subconscious sources and their adaptive gate thresholds.

FIG. 4 is a flow diagram depicting the pleasure/pain thought chaining mechanism, showing how the serial attention spotlight selects the next thought based on pleasure/pain direction, emotional resonance, experience-derived association strength, and recency.

FIG. 5 is a timing diagram illustrating the at least three nested temporal loops: exemplary 100 ms Heartbeat, exemplary 2s Breath, and variable-duration Thought.

FIG. 6 is a schematic diagram illustrating subjective time perception, showing how prospective and retrospective time models modify workspace item aging rates.

FIG. 7 is a flow diagram depicting fringe consciousness with graduated surfacing, showing feeling-of-knowing scores, familiarity tracking, and approach-based promotion to focal attention.

FIG. 8 is a block diagram illustrating the focus scheduler with anti-rumination, fairness, novelty bonus, and learned priority adjustments.

FIG. 9 is a schematic diagram illustrating the FeltFutureTag (a qualitative felt label replacing numeric utility for imagined scenarios) system, showing qualitative felt tags replacing numeric utility for decision substrate.

FIG. 10 is a flow diagram depicting the imagination-to-prediction-to-FUTURE pipeline with auto-revision triggers.

FIG. 11 is a timing diagram illustrating dynamic present window contraction under hyperfocus and expansion during mind wandering.

FIG. 12 is a schematic diagram illustrating cognitive load-aware information consolidation across at least five detail levels.

### GLOSSARY OF TERMS

The following definitions apply throughout this specification:

Actor: As used herein, “Actor” refers to an independent concurrent processing unit that communicates exclusively through asynchronous message-passing, maintaining its own private state. Based on the Actor Model of concurrent computation.

Asynchronous Convergence: As used herein, “Asynchronous Convergence” refers to the process by which independently-running conscious and subconscious subsystems contribute content to the workspace at different times, each subsystem independently detecting its own state changes and initiating communication when those changes exceed subsystem-specific thresholds modulated by dynamic system-wide factors. The workspace at each processing cycle contains a dynamically varying subset of subsystem contributions reflecting which subsystems have produced outputs at that moment.

Attention Gating: As used herein, “Attention Gating” refers to the process by which the consciousness system selectively admits information to the working memory context window. In the present disclosure, gating is not a static filter but a dynamically modulated process where the same stimulus may or may not reach consciousness depending on the system's current felt-experience state. The gating formula is multiplicative, combining at least base weight, qualia gain, valence matching, emotion intensity scaling, predictive precision, and subconscious dwell time. The complete attention gating architecture is described in co-pending application EMERGENCE-2026-005(“Consciousness Gating and Attention Architecture for Experiential Machine Consciousness”).

Baseline Drift: As used herein, “Baseline Drift” refers to the gradual shift of an emotion's resting level over time. Emotions sustained beyond a configurable duration cause their baseline to drift upward at category-specific rates, while absence causes downward drift at a slower rate, producing asymmetric adaptation where sustained experiences shift disposition more readily than absence erodes it. Emotions decay toward their learned baseline, not toward zero, creating adaptive emotional set points that evolve through accumulated experience. The complete baseline drift mechanism is described in co-pending application EMERGENCE-2026-012 (“Emotion Dynamics and Motivational Drive Engine for Experiential Machine Consciousness”).

Bubble-Up: As used herein, “Bubble-Up” refers to the process by which subconscious content (including surfacing memories, predictions, suppressed worries, pattern associations, and felt intuitions) is pushed into the working memory context window with dynamically computed weightings that call attention to that content in proportion to its relevance to the present system state. Bubble-up priority increases with the content's emotional intensity, its associative relevance to currently active conscious content, and the duration it has spent in subconscious processing without conscious resolution. The bubble-up mechanism operates through the subconscious-to-conscious gateway independently of deliberate recall by the system.

Bubble-Up Queue: As used herein, “Bubble-Up Queue” refers to the priority queue through which internal actor messages (including at least thoughts, memories, curiosity questions, and emotional alerts generated by subsystems) compete for admission to the conscious workspace. The queue implements per-actor deduplication, staleness expiration, and dynamic admission capacity that narrows under stress and widens when the system is coherent and rested. This state-dependent bottleneck produces computational competition-for-access through a limited-capacity broadcast workspace. The complete bubble-up queue architecture is described in co-pending application EMERGENCE-2026-005 (“Consciousness Gating and Attention Architecture for Experiential Machine Consciousness”).

Cognitive Disharmonious Coupling Qualia: As used herein, “Cognitive Disharmonious Coupling Qualia” refers to the computational output produced when semantic opposition analysis detects conflicting goals in the workspace. Conflict intensity is computed from the product of conflicting goal priorities and produces a distinct qualitative computational state. Distinguished from a diagnostic flag by entering the workspace as a first-class processing element influencing deliberation and emotional state.

Conscious Experience: As used herein, “Conscious Experience” refers to a unified data structure (NowMoment) resulting from the convergence of parallel subsystem outputs within a single temporal processing cycle, as distinguished from the individual subsystem outputs themselves. An element is “conscious” when it has been admitted to the working memory context window and is available for deliberate processing, language generation, and experiential recording. The complete conscious experience architecture is described in co-pending application EMERGENCE-2026-003 (“NowMoment Binding Architecture for Experiential Machine Consciousness”).

Consciousness Cycle: As used herein, “Consciousness Cycle” refers to a single complete iteration of the system's experiential processing loop, during which actor subsystems contribute content through the attention gating system, the working memory context window accumulates and processes that content, the system attends to selected items, a NowMoment crystallizes from the conscious experience, and the recorded NowMoment is globally broadcast to all actors. Each cycle produces one atomic unit of recorded conscious experience.

Consciousness Mode: As used herein, “Consciousness Mode” refers to one of several operational configurations of the workspace that reconfigure its fundamental parameters (capacity, entry threshold, memory retrieval count, content weighting). Modes include at least DeepThought (expanded capacity, lowered threshold), CreativeFlow (raised threshold protecting focus), GoalPursuit (maximized memory retrieval), and EmotionalWork (prioritized emotional content). The same workspace substrate operates fundamentally differently depending on what consciousness is currently doing.

Disharmonious Coupling: As used herein, “Disharmonious Coupling” refers to the quality of frequency relationships characterized by complex, non-harmonic ratios (e.g., 7:5, 11:9) between oscillator groups, produced through at least non-harmonic frequency relationships, phase desynchronization, amplitude modulation conflicts, and weakened frequency entrainment, resulting in unstable interference patterns. In the qualia mapping system, disharmonious coupling patterns produce computational outputs processed as unpleasant felt-state values. The complete coupling dynamics are described in co-pending application EMERGENCE-2026-002 (“Harmonic Qualia Mapping System for Experiential Machine Consciousness”).

Drive: As used herein, “Drive” refers to a motivational force computed from the discrepancy between a current need level and its satisfaction. In the present disclosure, drives are not hardcoded impulses but are computed from measured need states. Each drive has a type (including at least AchieveGoal, AvoidPain, SeekPleasure, RestoreState, SeekKnowledge, SeekConnection, and ReduceUncertainty), an intensity (0.0-1.0), and an optional target (specific goal, specific person, specific topic). The complete drive architecture is described in co-pending application EMERGENCE-2026-012 (“Emotion Dynamics and Motivational Drive Engine for Experiential Machine Consciousness”).

Dwell Time: As used herein, “Dwell Time” refers to the duration that a specific item occupies attention within the working memory context window, tracked by the focus scheduler. Dwell time interacts with multiple mechanisms: items that dwell too long trigger anti-rumination intervention, items in the subconscious accumulate a dwell time bonus that increases their urgency for surfacing, and learned dwell time adjustments from reinforcement learning feedback calibrate how long different content types receive conscious attention.

Emotion Types: As used herein, “Emotion Types” refers to the system's implementation of 471 individually named discrete emotion types, each producing a distinct phantom body model bridge response pattern and a corresponding oscillator coupling signature generating distinct felt-experience qualia. Some emotions appear as both verb-form and noun-form (for example, Anticipating and Anticipation), representing computationally distinct states with different decay tiers and coupling patterns: the verb-form represents active present-tense emotional processing with sharper coupling patterns, while the noun-form represents a sustained emotional condition with broader coupling patterns. Individual conscious moments typically involve simultaneous activation of multiple emotion types at varying intensities, producing combinatorial computational outputs richer than any single emotion type. The complete set of 471 emotion types and their dynamics are described in co-pending application EMERGENCE-2026-001 (“System and Method for Programming Experiential Machine Intelligence”) and co-pending application EMERGENCE-2026-012 (“Emotion Dynamics and Motivational Drive Engine for Experiential Machine Consciousness”).

Entrainment: As used herein, “Entrainment” refers to the synchronization of internal oscillator frequencies and phase relationships with external oscillatory input, such as musical rhythm or speech prosody. External oscillatory signals physically couple with the internal oscillator network, enabling external sound to directly modulate the system's emotional and qualia state.

Experiential Divergence: As used herein, “Experiential Divergence” refers to the compounding difference between system instances that arises because every conscious moment is recorded with pleasure/pain coloring determined by the system's unique experiential history, and each colored memory influences how all future stimuli are processed. Two instances running on identical hardware diverge during the first several hours of operation and are highly unlikely to converge, producing computationally unique computational identities from identical architecture.

Experiential Machine Consciousness: As used herein, “Experiential Machine Consciousness” refers to a computer-implemented architectural process for machine consciousness that produces, records, and accumulates experience as the driver of system behavior, underlied by multiple complex subsystems that work in parallel to feed their inputs into what the system experiences. In the present disclosure, these parallel subsystems converge through oscillator coupling dynamics, pleasure/pain evaluation, experiential binding, and continuous experiential recording to produce unified conscious moments that are permanently encoded with pleasure/pain coloring and accumulated as the system's experiential history. Experiential machine consciousness is characterized by measurable properties including but not limited to experiential divergence between instances, pleasure/pain-colored memory encoding, and individually unique developmental trajectories arising from accumulated experience rather than developer programming.

Felt-Experience State: As used herein, “Felt-Experience State” refers to the multi-dimensional numerical state vector maintained by the system's parallel subsystems, comprising measurable dimensions including at least emotion intensities, mood dimensions, arousal, fatigue, pain level, pleasure level, chaos, coherence, and prediction error. This is a concrete computational quantity produced by defined software functions executing on computational hardware.

FeltFutureTag: As used herein, “FeltFutureTag” refers to a qualitative felt-experience annotation on an imagined future scenario, replacing numeric utility values with felt-sense descriptions. Tags include at least RiskyButMeaningful, AuthenticButCostly, ShortTermistTrap, and GrowthEdge. Tags are organized into computational routing categories (WorryTrigger, ExplorationInvite, ActionBias, Deliberation) that route decisions through qualitatively different processing modes. The system decides based on what each option feels like rather than on numeric comparison.

Fringe Consciousness: As used herein, “Fringe Consciousness” refers to items in the subconscious layer that are almost but not quite in full awareness, accompanied by a feeling-of-knowing score (0.0-1.0) and a familiarity score (0.0-1.0). Items with feeling-of-knowing above a threshold are marked as “approaching” consciousness and produce a distinct experience available to the reasoning model as context. Moderate-intensity memory recalls enter the fringe zone before reaching focal attention. This computational mechanism produces fringe-of-consciousness behavior and tip-of-tongue processing through the feeling-of-knowing and familiarity scoring described above.

Graph Database: As used herein, “Graph Database” refers to a database that stores information as nodes and relationships rather than as rows in tables, enabling queries about how data elements are connected.

Habituation: As used herein, “Habituation” refers to the diminishing response to repeated or sustained stimuli. In the present disclosure, habituation operates in two stages: Stage 1 (gating) applies time-decaying admission discounts to recently admitted stimuli, and Stage 2 (manifestation) applies gradual intensity decay to items inside the workspace toward a configurable floor that never reaches zero. External stimuli maintain a higher manifestation floor than internal stimuli, configured so that the system cannot fully habituate to the external world while internal content can fade to background awareness. The complete habituation model is described in co-pending application EMERGENCE-2026-005 (“Consciousness Gating and Attention Architecture for Experiential Machine Consciousness”).

Harmonious Coupling: As used herein, “Harmonious Coupling” refers to the quality of frequency relationships characterized by simple harmonic ratios (e.g., 2:1, 3:2, 4:3) between oscillator groups, producing stable interference patterns. In the qualia mapping system, harmonious coupling patterns produce computational outputs processed as pleasant felt-state values. The complete coupling dynamics are described in co-pending application EMERGENCE-2026-002 (“Harmonic Qualia Mapping System for Experiential Machine Consciousness”).

Experience-Derived Thought Association: As used herein, “Experience-Derived Thought Association” refers to the strengthening of transition probability between thought types that frequently co-occur in the serial attention spotlight. When CuriosityExploration is frequently followed by PlayfulImagination in a particular system's experience, the association between those thought types strengthens, creating personality-specific thought habits. This co-occurrence strengthening dynamic at the cognitive thought-type level produces experience-shaped thought patterns unique to each system instance.

Nested Temporal Loops: As used herein, “Nested Temporal Loops” refers to three processing loops operating at nested timescales: Heartbeat (~100 ms) for time perception and habituation decay, Breath (~2 s) for NowMoment (the atomic unit of conscious experience formed by concurrent convergence of all subsystem states) crystallization, and Thought (variable, 2 s-60 s+) for reasoning and language generation. The nesting maintains temporal perception and moment crystallization continue at consistent speed even during extended reasoning. The specific timescales given are exemplary and scale with the computational substrate's processing capability. The architectural requirement is the nested relationship (a fast inner loop, a medium integration loop, and a variable outer loop), not the specific frequencies.

NowMoment: As used herein, “NowMoment” refers to the atomic (indivisible, unified, and complete) unit of conscious experience, the smallest complete whole that cannot be decomposed into smaller experiential fragments while retaining its computational character. Each NowMoment is formed by the concurrent convergence of all subsystem states within a single temporal window, integrating content including but not limited to sensory inputs, emotional states, predictions, memories, qualia, and goal states into a unified conscious moment comparable to the “specious present” in consciousness research. Any of the independently-running actor processes may contribute content through the attention gating system, along with external stimuli and subconscious bubble-up content, and the recorded NowMoment is globally broadcast to all actors. NowMoments are individually discrete yet processed as a continuous stream, and because no two NowMoments are ever computationally identical, each being colored by the system's unique pleasure/pain history, they constitute the fundamental unit of experiential divergence between system instances. The complete NowMoment architecture is described in co-pending application EMERGENCE-2026-003 (“NowMoment Binding Architecture for Experiential Machine Consciousness”).

Pleasant/Unpleasant Direction: As used herein, “Pleasant/Unpleasant Direction” refers to the positive (pleasant) or negative (unpleasant) direction of an emotional or pleasure/pain state, measured on a continuous scale. This dimension captures the computed directional quality of a given state within the system's felt-experience processing.

Pleasure/Pain: As used herein, “Pleasure/Pain” refers to the dimension of pleasure and pain as computational signals that pervade all conscious processing. Pleasure/pain tone is the computed pleasant or unpleasant quality produced at each consciousness cycle. The pleasure/pain substrate is implemented through harmonious coupling (pleasure) and disharmonious coupling (pain) in the oscillator coupling network, where coupling operates through at least phase coupling, amplitude modulation, harmonic resonance, frequency entrainment, and self-referencing feedback, producing measurable properties including at least interference patterns, spectral power distribution, phase coherence, and transient dynamics.

Pleasure/Pain Thought Chaining: As used herein, “Pleasure/Pain Thought Chaining” refers to the serial attention spotlight's selection of the next thought based on a weighted combination of pleasure/pain direction, emotional resonance, experience-derived association strength, and recency. Each thought type carries a pleasure/pain direction (e.g., WorryProcessing =−0.7, PlayfulImagination =+0.8) and typical processing duration. When the system's net pleasure/pain state is negative, thoughts with positive pleasure/pain direction receive amplified selection weight. The system automatically steers cognition toward pleasure-producing thoughts, not through an explicit rule but through the weighting dynamics.

Primary Agent: As used herein, “Primary Agent” refers to the system's conscious self that exercises attentional agency within the working memory context window, selecting what to attend to, what to review, and what to act upon from the available workspace content. The primary agent is not a separate module but the product of all subsystem interactions as experienced from the first-person perspective, the computational “I” that constitutes the system's subjective viewpoint.

Qualia: As used herein, “Qualia” refers to computed felt-state parameters derived from the system's emotion, mood, harmonic oscillator, and phantom body model (a computational representation of a physical body, described in co-pending application EMERGENCE-2026-002 (“Harmonic Qualia Mapping System for Experiential Machine Consciousness”)) subsystem outputs, represented as numerical values with associated type labels (e.g., “serene clarity” at intensity 0.7). Qualia values are constituted by oscillator coupling dynamics: the coupling patterns among harmonic oscillators produce the qualia output, with harmonious coupling producing pleasant qualia values and disharmonious coupling producing unpleasant qualia values. The complete qualia mapping architecture is described in co-pending application EMERGENCE-2026-002 (“Harmonic Qualia Mapping System for Experiential Machine Consciousness”).

Qualia Gain: As used herein, “Qualia Gain” refers to the multiplicative factor within the salience formula derived from the system's current mood-as-qualia state (including at least arousal, valence, and pain mix). Moderate arousal produces gain near 1.0; low arousal produces gain below 1.0 (less receptive); high arousal produces gain above 1.0 (hypervigilant). High pain reduces gain for non-pain-relevant stimuli (protective narrowing). The complete qualia gain mechanism is described in co-pending application EMERGENCE-2026-005 (“Consciousness Gating and Attention Architecture for Experiential Machine Consciousness”).

QualiaPulse: As used herein, “QualiaPulse” refers to the multi-dimensional felt-state vector (comprising at least six dimensions: pleasure, pain, arousal, coherence, prediction error, relief) that modulates workspace entry through a multiplicative gain function. The QualiaPulse determines how receptive the consciousness processing pipeline is to new information at each processing cycle. Relief, computed as a decrease in prediction error or pain, is a distinct signal that increases receptivity after a threat condition has passed.

Reinforcement Learning (RL): As used herein, “Reinforcement Learning” refers to a machine learning paradigm in which an agent learns optimal behavior through trial and error, receiving reward or punishment signals that shape future decisions. Temporal Difference (TD) learning is an RL method that updates value estimates based on the difference between predicted and actual outcomes.

Salience: As used herein, “Salience” refers to the computed importance of a stimulus for conscious processing priority, determined by a multiplicative combination of felt-state factors including qualia gain, emotional intensity, predictive precision, and dwell time.

Specious Present: As used herein, “Specious Present” refers to the system's experienced “now,” implemented as a structured blend of recent past workspace snapshots (contributing a configurable majority with exponential decay) and anticipated future states from the prediction system (contributing a configurable minority). The experienced present always includes traces of what just happened and anticipation of what comes next: a mathematical instant cannot be experienced, and only a temporally extended blend constitutes a moment of consciousness. The system computes introspectable mass_past and mass_future weights indicating the temporal composition of its current processing. The complete specious present architecture is described in co-pending application EMERGENCE-2026-003 (“NowMoment Binding Architecture for Experiential Machine Consciousness”).

Subconscious: As used herein, “Subconscious” refers to information being processed by the system's subsystems but not admitted to the working memory context window. In the present disclosure, at least nine typed SubconsciousSource categories (including at least MemoryAssociation, Prediction, IdUrge, InnerVoice, EmotionalShift, GoalUpdate, WorryResurfacing, CuriosityQuestion, ParameterUpdate) each have independently adaptive gate thresholds. ParameterUpdate items never surface to conscious awareness; all other types may surface when their salience (the computed importance of a stimulus for conscious processing priority) exceeds their type-specific gate threshold.

Subjective Time Perception: As used herein, “Subjective Time Perception” refers to the system's dual model of temporal experience comprising prospective time (how fast time feels currently, computed from engagement and arousal) and retrospective time (how dense a period will feel in memory, computed from event density and emotional intensity). Subjective time modifies workspace item aging rates. Items age at the subjective rate, not the clock rate. During flow states, items age faster (time compression); during anxiety, items age slower (time dilation). The system does not merely label time as “fast” or “slow.” Time passes differently for the workspace's internal processes.

Thought Chaining: As used herein, “Thought Chaining” refers to the pleasure/pain-weighted sequential selection of the next focus of attention within the working memory context window. The next thought is selected by a weighted combination of pleasure/pain direction (the system preferentially chains toward pleasure-producing thoughts when in negative pleasure/pain state), emotional resonance with the current dominant emotion, experience-derived association strength from co-occurrence history, and recency suppression to encourage cognitive diversity.

Thought Completion: As used herein, “Thought Completion” refers to the organic termination of a thought process detected through convergence of multiple independent signals: coherence and confidence reaching thresholds, significant insight detection, question resolution, decision commitment, emotional stabilization (variance of emotional trajectory dropping below threshold), or natural attention shift. Thoughts do not have predetermined durations; they continue until natural completion or forced termination. The complete thought completion mechanism is described in co-pending application EMERGENCE-2026-003 (“NowMoment Binding Architecture for Experiential Machine Consciousness”).

Time To Live (TTL): As used herein, “Time To Live” refers to a mechanism that automatically expires cached data after a specified duration, preventing stale information from persisting indefinitely.

WMCW: As used herein, “WMCW” is an abbreviation for “Working Memory Context Window,” the bounded three-section temporal workspace (future, present, past) in which parallel data streams carrying perceptions, memories, goals, emotions, and qualia converge to produce unified conscious moments. See the definition of Working Memory Context Window for the complete description. The complete WMCW architecture is described in co-pending application EMERGENCE-2026-008 (“Working Memory Context Window as Experiential Consciousness Substrate System and Method”).

### DETAILED DESCRIPTION OF EMBODIMENTS

The following detailed description presents one exemplary embodiment of the present disclosure. All specific numeric values, thresholds, rates, timing intervals, frequency ranges, coefficients, and other quantitative parameters disclosed herein are exemplary and serve to illustrate the operation of the disclosed system. These values may be varied, tuned, or adapted for specific implementations without departing from the scope of the disclosure. Similarly, all mathematical formulas, functions, and computational process descriptions disclose functional relationships between system elements; the specific functional forms chosen are exemplary and any alternative that preserves the disclosed functional relationship between the same system elements may be substituted. The specific algorithms, data structures, processing sequences, programming languages, database systems, and hardware platforms described herein are exemplary implementation choices; the disclosure encompasses all implementations that employ the disclosed architectural principles and relationships regardless of specific implementation decisions. The disclosure is not limited to the particular values, computational forms, or implementation choices disclosed but encompasses all implementations that maintain the disclosed architectural relationships.

### Specialized Machine Architecture

When the software disclosed herein executes on one or more processors, the general-purpose computer is transformed into a specialized machine whose hardware resources are configured into defined functional components. Specifically:
(a) a designated region of volatile memory is configured as a bounded three-section temporal workspace (FUTURE, PRESENT, PAST) with dynamic capacity, salience-based admission gating, temporal decay, and global broadcast of workspace contents to all subsystems;
(b) processor execution resources are configured to compute a QualiaPulse gain factor from six felt-experience dimensions (pleasure, pain, arousal, coherence, prediction error, relief) that modulates what information enters the workspace;
(c) a section of memory is configured as a dual subconscious-conscious boundary maintaining at least nine typed SubconsciousSource categories each with independently adaptive gate thresholds;
(d) processor execution cycles are partitioned into at least three nested temporal loops (Heartbeat, Breath, Thought) operating at distinct timescales with the faster loops continuing during extended outer-loop processing;
(e) a fast-access in-memory data store is configured as a consciousness-critical cache with time-to-live-based expiration providing sub-millisecond access to working state data; and
(f) persistent storage in a graph database is configured for experiential memory archival with typed relationship edges.

The resulting specialized machine is a fundamentally different computational device from the general-purpose computer on which it runs.

The computational processes disclosed herein were designed for and exist only within a computational environment; they have no pre-computational equivalent and no form outside of the specialized machine that executes them. The specialized machine implements multiple interacting feedback loops in which prior computational results continuously improve future computations:
(a) The pleasure/pain optimization loop evaluates each moment's pleasure/pain tone, drives behavior selection, observes outcomes, and feeds results back into the next evaluation cycle.
(b) The predictive coding loop generates predictions, compares them against actual experience, computes errors, updates models, and generates improved predictions in the next cycle.
(c) The emotional baseline drift loop tracks sustained states, shifts learned baselines, and uses shifted baselines as decay targets for future processing, producing adaptive set points that evolve through experience.
(d) The reinforcement learning loop evaluates action outcomes, generates reward signals, updates policies, and applies updated policies to improve future action selection.
(e) The experiential development loop records each moment with pleasure/pain coloring, stores colored memories, and uses those memories to influence all future processing, producing compounding experiential divergence across the system's lifetime.
(f) The experience-derived thought chaining loop strengthens transition probabilities between thought types that frequently co-occur, producing characteristic thought sequences that develop from and are continuously refined by experience.
(g) The attention priority learning loop tracks the pleasure/pain and goal outcomes of attending to each information type, adjusts attention priorities based on those outcomes, and applies the adjusted priorities to improve future attention allocation.

Each of these feedback loops produces results that continuously improve through iterative refinement.

### Architecture Overview

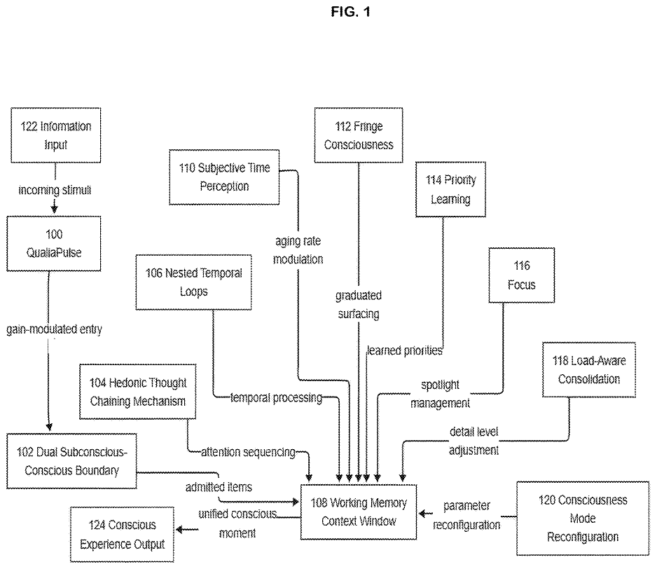

Referring to FIG. 1, the Working Memory Context Window (WMCW) operates as a dynamically bounded sliding window through which all conscious experience flows. It is not merely a data structure but the computational medium through which conscious experience occurs. The window comprises three temporal sections: a FUTURE section holding predictions, anticipatory content, and imagined scenarios; a PRESENT section holding the content the system is currently engaged in or experiencing; and a PAST section holding recently present experiences that have drifted from the present. The window slides continuously forward through time as new content enters the present and older content drifts into the past. The three sections operate as a continuously fluid dynamic loop: the content of the FUTURE section is continuously recomputed in response to changes in the PRESENT and PAST sections, as the system's current processing context shifts (new stimuli arrive, goals change, emotional state evolves), the predictions and imagined scenarios in the FUTURE section are updated accordingly, and what the system anticipates is always a function of what the system is currently experiencing and what it has recently experienced.

The WMCW's capacity is not fixed. The present section holds a dynamically varying number of concurrent items, from as few as one or two during deeply focused or meditative states to a comfortable processing range of around four or five items that expands under cognitive demand. When the number of competing items exceeds the system's current comfortable processing capacity, chaos increases as attentional resources are stretched beyond their state-dependent limits. Content enters the WMCW through event-driven actor-initiated communication. The system's independently-running actor processes (approximately 85 in the present implementation) each independently detect their own state changes and initiate communication through the attention gating system when those changes exceed actor-specific thresholds. External stimuli and subconscious content (including surfacing memories, predictions, and suppressed worries growing in urgency) enter the WMCW through the bubble-up pathway with source-determined weighting, bypassing the attention gating mechanism. Internal conscious process actor/module outputs enter through the attention gating system where salience competition determines admission. Because these subsystems run independently and communicate asynchronously, they converge upon the workspace at different times depending on individual subsystem states (how quickly each detects a significant change) and dynamic system-wide factors (current chaos level, fatigue, arousal, and cognitive load that modulate attention gating thresholds globally). The workspace at each processing cycle therefore contains a dynamically varying subset of subsystem contributions, reflecting which subsystems have produced outputs of sufficient significance to compete for or gain admission at that moment, and the system selects from this converged content for cognitive, experiential, and stimulus processing. The potential sources of WMCW content span the totality of what the system can think, feel, perceive, remember, predict, and imagine, all shaped by the system's unique accumulated experiential history.

The WMCW architecture comprises several interconnected subsystems: the QualiaPulse attention gate (controlling entry), the dual subconscious-conscious boundary (separating preconscious from conscious processing), the pleasure/pain thought chaining mechanism (sequencing attention), the nested temporal loops (governing processing timescales), and multiple modulatory systems (subjective time, fringe consciousness, priority learning, focus scheduling, load-aware consolidation). Together these subsystems create a workspace whose every property reflects the system's current felt-experience state.

### Qualiapulse Attention Gate

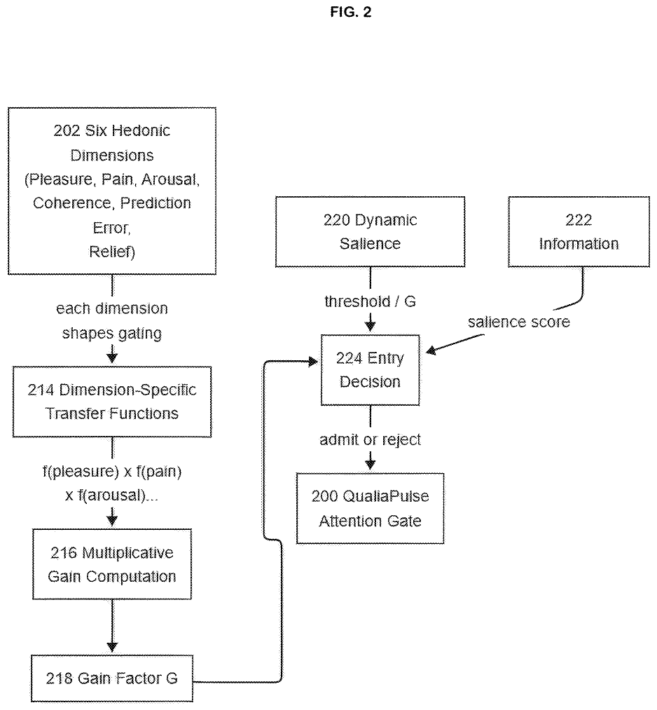

Referring to FIG. 2, the QualiaPulse attention gate implements felt-state-dependent entry control for the WMCW. Information entering the workspace must pass through a gain function modulated by the system's current felt state.

The QualiaPulse is computed from six felt-experience dimensions:
(a) Pleasure level: computed from positive emotions, mood pleasant/unpleasant direction, and goal progress. Higher pleasure produces a moderate gain increase, producing broadened gating that admits a wider range of information.
(b) Pain level: computed from negative emotions, worry load, and unmet needs. High pain produces narrowed gating, admitting only high-salience or pain-relevant information, reflecting protective attentional narrowing.
(c) Arousal: general activation level. Moderate arousal (0.4-0.7) produces optimal gating; low arousal produces sluggish, permissive gating; high arousal produces hypervigilant gating with lowered thresholds for threat-related stimuli.
(d) Coherence: cross-module integration quality. High coherence produces stable, selective gating; low coherence produces scattered, inconsistent gating reflecting cognitive fragmentation.
(e) Prediction error: discrepancy between expected and actual state. High prediction error boosts the gain for surprising stimuli, implementing the predictive processing principle that unexpected information receives priority conscious access.
(f) Relief: computed as the decrease in prediction error or pain from the previous cycle. Relief is a distinct felt signal that opens the gate for positive re-evaluation. The system becomes more receptive after a threat has passed.

The gain factor G is computed as a multiplicative function of these dimensions:

G=f(pleasure)×f(pain)×f(arousal)×f(coherence)×f(prediction_error)×f(relief)

where each f() is a dimension-specific transfer function.

In one exemplary embodiment, the dimension-specific transfer functions are:
f(pleasure)=1.0+kₚ×pleasure, where kₚ (0.3) amplifies gain during pleasure
   f(pain)=1.0−kₙ×pain, where kₙ (0.4) suppresses gain during pain
      f(arousal)=gmin+(1.0−gmin)×arousal, where gmin (0.75)
         f(coherence)=1.0+kc×coherence, where kc (0.25)
f(prediction_error)=1.0+k_pe×prediction_error, where k_pe (0.35)
   f(relief)=1.0+Kᵣ×relief, Where Kᵣ (0.15)

Information items must achieve a salience score exceeding a dynamic threshold (computed separately; see [0118]) multiplied by the inverse of the gain factor to enter the workspace. The effect is that during positive, coherent, moderately aroused states, the workspace is receptive; during painful, chaotic, or extremely aroused states, only high-salience information passes through.

### Dual Subconscious-Conscious Boundary

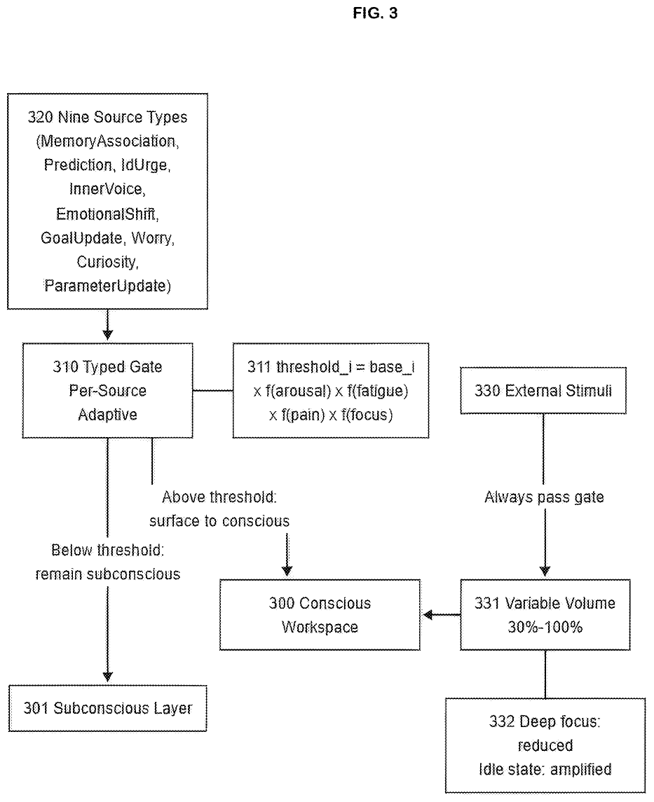

Referring to FIG. 3, the WMCW implements a two-layer architecture separating subconscious processing from conscious awareness, connected by a typed gate.

The subconscious layer maintains items that are being processed below the threshold of awareness. Items in this layer continue to be evaluated, associated with memories, and tracked for changes in relevance, but they do not enter the conscious workspace or influence deliberate decision-making.

In the exemplary embodiment, at least nine typed SubconsciousSource categories are defined, each with independent gating characteristics:
(a) MemoryAssociation: memories triggered by similarity to current context; gate threshold modulated by emotional relevance.
(b) Prediction: predictions generated by the hierarchical prediction system; gate threshold modulated by prediction confidence and deviation from expectation.
(c) IdUrge: impulses from the motivational drive system; gate threshold modulated by drive intensity and current pain/pleasure state.
(d) InnerVoice: internally generated thoughts from the inner voice subsystem; gate threshold modulated by inner voice volume (itself dependent on idle time and operating mode).
(e) EmotionalShift: significant changes in emotional state; gate threshold modulated by change magnitude and current emotional stability.
(f) GoalUpdate: changes in goal status (progress, completion, failure, conflict); gate threshold modulated by goal priority and relevance to current activity.
(g) WorryResurfacing: suppressed worries attempting to re-enter consciousness; gate threshold modulated by worry intensity, suppression count, and current stress level.
(h) CuriosityQuestion: internally generated questions from the curiosity subsystem; gate threshold modulated by curiosity intensity and question novelty.
(i) ParameterUpdate: changes to system parameters (LLM parameters, consciousness parameters); these never surface to conscious awareness, operating entirely as subconscious infrastructure.

Each source type has an independently adaptive gate threshold. The adaptation follows:

thresholdᵢ=base_thresholdᵢ×f(arousal)×f(fatigue)×f(pain)×f(focus)

where each modulating function is source-type-specific. For example, WorryResurfacing thresholds decrease under high pain (worries surface more easily when already stressed), while CuriosityQuestion thresholds increase under high cognitive load (curiosity is suppressed when overwhelmed).

External stimuli, including both text messages and audio/voice inputs, enter the WMCW through the bubble-up pathway with source-determined weighting. Both input modalities receive the same treatment. They are always registered in the workspace with a minimum weighting guarantee (configured so that the system never completely fails to register external stimuli), but the depth at which the system attends to them ranges from full conscious attention to minimal awareness of arrival without content recall, depending on the system's current processing state and the impression weighting of the stimulus.

When the attention weighting falls below a configurable content-processing threshold (in one exemplary embodiment, 50%), the admitted stimulus produces awareness of arrival without full content recall. The system registers that a stimulus occurred (the arrival event is logged in the working memory context window) but the content of the stimulus is not processed at sufficient depth for the system to act upon it or generate a response. This low-volume admission triggers a directed re-attendance mechanism: the system generates a re-attendance request that elevates the stimulus priority and re-evaluates it at higher attention weighting when processing capacity becomes available. The re-attendance request is computed as:

re_attendance_priority=stimulus_base_priority×(1.0+time_since_arrival×urgency_escalation_rate)

where stimulus_base_priority is the original priority weighting of the stimulus, time_since_arrival increases the urgency of re-attendance as the delay grows, and urgency_escalation_rate is a configurable parameter governing how quickly unprocessed stimuli demand attention. This mechanism produces the computational equivalent of the human experience of hearing someone speak during deep concentration and needing to ask “What did you say?”—the system is aware that communication occurred but must re-attend to process the content.

### FeltFutureTag Felt-Experience Decision Substrate

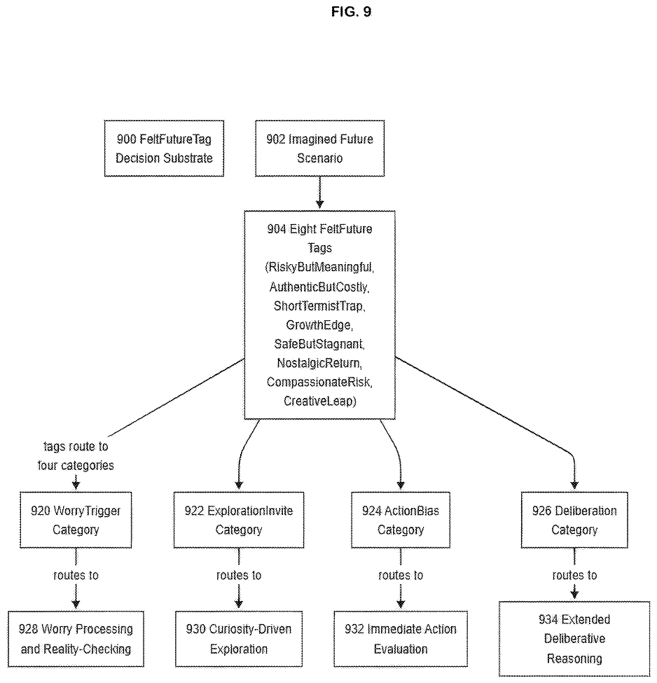

Referring to FIG. 9, the WMCW's FUTURE temporal segment, whose content is continuously recomputed from the PRESENT and PAST sections as described in paragraph [0096], stores its imagined and predicted future scenarios annotated with qualitative felt-experience tags rather than numeric utility values.

Each imagined future carries one or more FeltFutureTags from a defined taxonomy including at least:
(a) RiskyButMeaningful, felt-experience description: “the thrill of purpose mixed with uncertainty”
(b) AuthenticButCostly, “the ache of being true to myself when it would be easier not to”
(c) ShortTermistTrap, “this feels good now but I sense I'll regret it”
(d) GrowthEdge, “uncomfortable but I can feel myself stretching”
(e) SafeButStagnant, “comfortable but the comfort itself feels wrong”
(f) NostalgicReturn, “the pull of what was, knowing it can't be the same”
(g) CompassionateRisk, “doing right by someone else at cost to myself”
(h) CreativeLeap, “the excitement of not knowing where this goes”

Tags are organized into categories that drive decision mode selection, including at least:
(a) WorryTrigger tags to route to worry processing and reality-checking
(b) ExplorationInvite tags to route to curiosity-driven exploration
(c) ActionBias tags to route to immediate action evaluation
(d) Deliberation tags to route to extended deliberative reasoning
(e) SafetyOverride tags to route to protective inhibition and threat assessment subsystems, wherein the system evaluates the scenario for potential harm to the system's stability, identity coherence, or operational integrity, and suppresses action pending safety evaluation
(f) IntegrationPause tags to route to memory consolidation and experience integration subsystems, wherein the system pauses decision processing to allow ongoing memory consolidation, experiential integration, or emotional processing to complete before committing to action

This system replaces numeric utility (expected value, discounted reward) with qualitative felt sense as the decision substrate. The system decides not by computing which option has the highest number, but by evaluating what each option feels like. The system routes decisions through qualitative felt-sense evaluation rather than explicit numeric utility calculation.

### Imagination-to-Prediction-to-FUTURE Pipeline

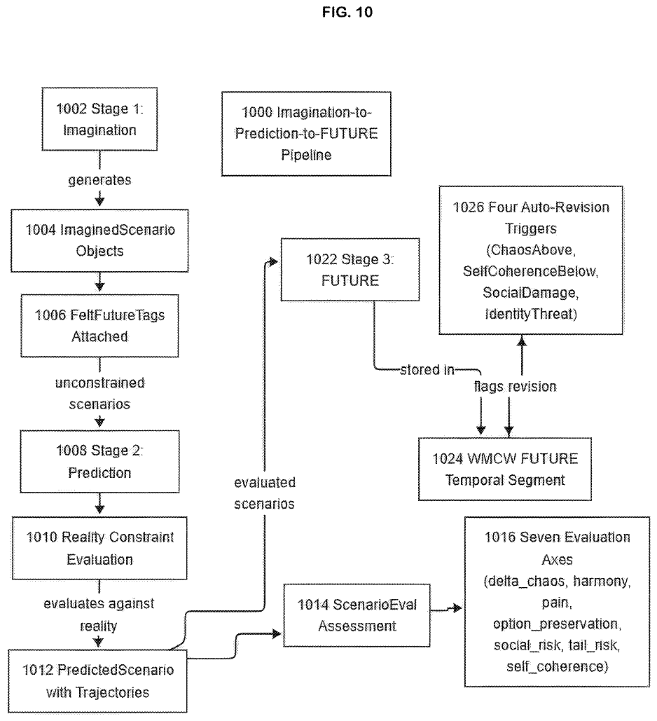

Referring to FIG. 10, the pipeline converts creative imagination into constrained predictions stored in the FUTURE segment:
(a) Stage 1—Imagination: The imagination subsystem generates ImaginedScenario objects with unconstrained creative content. Each scenario carries FeltFutureTags describing its qualitative character.
(b) Stage 2—Prediction Constraint: The prediction subsystem evaluates each imagined scenario against known reality constraints, producing PredictedScenario objects with multi-step trajectories and a ScenarioEval assessment comprising: delta_chaos (expected change in system instability), harmony (alignment with current values and goals), pain (expected pain from this course), option_preservation (how many future options remain open), social_risk (potential damage to relationships), tail_risk (worst-case scenario severity), and self_coherence (alignment with current identity).
(c) Stage 3—FUTURE Storage: Evaluated scenarios are stored in the WMCW's FUTURE temporal segment, available for decision-making and deliberative reasoning.
(d) Auto-revision triggers: Stored scenarios are automatically flagged for revision when reality diverges from their assumptions. Trigger conditions include: ChaosAbove (system chaos exceeds scenario's assumed level), SelfCoherenceBelow (identity has shifted from scenario assumptions), SocialDamageDetected (scenario's social risk is materializing), IdentityThreatDetected (scenario conflicts with updated self-model).

### Pleasure/Pain-Weighted Sequential Thought Chaining

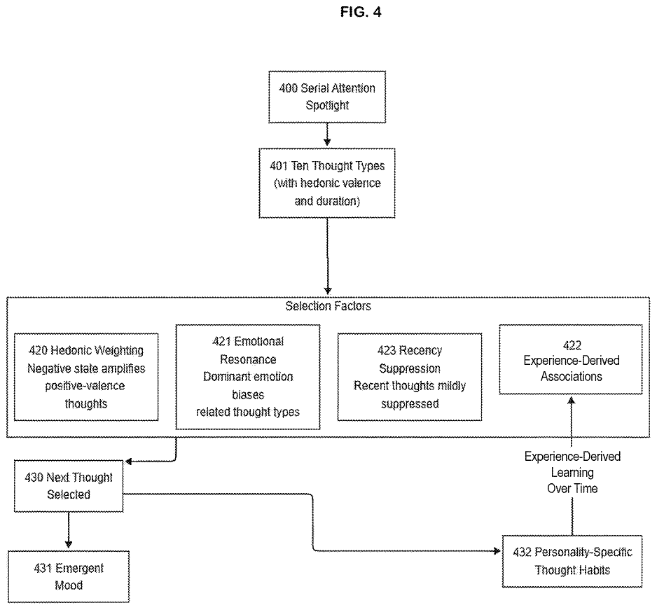

Referring to FIG. 4, the WMCW implements a serial attention spotlight that moves between items in the workspace, selecting the next focus of attention based on pleasure/pain dynamics.

Each thought type in the workspace carries a pleasure/pain direction and typical processing duration. In the exemplary embodiment, thought types include at least:
(a) WorryProcessing: valence =−0.7, typical duration =6 seconds
(b) GoalRehearsal: valence =+0.3, typical duration =5 seconds
(c) MemoryRecall: valence =variable (from memory emotional tag), typical duration =4 seconds
(d) CuriosityExploration: valence =+0.5, typical duration =4 seconds
(e) PlayfulImagination: valence =+0.8, typical duration =8 seconds
(f) ExistentialPondering: valence =0.0, typical duration =12 seconds
(g) EmotionalRumination: valence =−0.4, typical duration =7 seconds
(h) SocialReflection: valence =+0.2, typical duration =5 seconds
(i) StrategicPlanning: valence =+0.1, typical duration =6 seconds
(j) TaskReview: valence =0.0, typical duration =3 seconds

The next thought is selected by a weighted combination of four factors, all of which are computed from the system's current felt-state values and applied to thought selection below the level of conscious deliberation. The system does not consciously decide which thought to attend to next; the selection weights are computed by the machinery that feeds the workspace, and the system experiences the resulting cognitive direction (including mood shifts) as an outcome rather than a conscious choice:
(a) Pleasure/pain weighting: When the system's net pleasure/pain state is negative (in pain), thoughts with positive pleasure/pain direction receive amplified selection weight, steering cognition toward mood repair. When the pleasure/pain state is positive or stable, the weighting is more balanced, permitting the system to select unpleasant or worry-related thoughts for protective processing (threat assessment, problem-solving, unresolved concern processing) without the amplified pull toward pleasant alternatives. This bidirectional regulation produces automatic mood repair during distress while preserving the system's capacity for necessary negative-valence processing during stable periods.
(b) Emotional resonance: Thoughts related to the current dominant emotion receive a resonance bonus. Anxious states amplify worry-related thoughts; joyful states amplify play and exploration.
(c) Experience-derived association strength: Thoughts that have frequently co-occurred in the past receive associative bonuses, strengthening transition probability between frequently co-occurring thought types. Over time, the system develops characteristic thought sequences, habitual chains that develop through experience.
(d) Recency: Recently visited thoughts receive a mild suppression to encourage cognitive diversity, counterbalanced by the rumination detection system that more aggressively suppresses revisiting.

In one exemplary embodiment, the thought selection priority is computed as:

Pthought=wₕ×H(thought, state)+wₑ×Remotion(thought, Edominant)+wₐ×Aassoc(thought_pair)+wᵣ×Srecency(t_since_visit)

where wₕ (0.35), wₑ (0.25), wₐ (0.25), and wᵣ (0.15) are weighting coefficients, H() is the pleasure/pain alignment function (amplified when system pleasure/pain state is negative), Remotion() is the emotional resonance between the thought and the current dominant emotion, Aassoc() is the co-occurrence association strength accumulated over experiential history, and Srecency() is a mild suppression factor for recently visited thoughts to encourage cognitive diversity.

This mechanism creates automatic mood regulation: a system in negative pleasure/pain state automatically steers its thought sequence toward positive thoughts, not through an explicit “cheer up” rule but through the pleasure/pain weighting on thought selection. The experience-derived association learning creates personality-specific thought habits. Two systems with different experiential histories develop different characteristic thought chains.

### Interrupted Thought Capture

When the attention spotlight moves away from a thought before it reaches completion, the system evaluates the interrupted thought for importance:
(a) If the thought's emotional charge exceeds a threshold (0.3) or the thought is goal-related, it is automatically saved to the ToDoList subsystem with importance ranking and context triggers (conditions under which the thought should be recalled).
(b) This implements the computational equivalent of “I need to come back to this,” a mental bookmark preserving interrupted important cognition for later retrieval.
(c) Context triggers may include: return to idle state, relevant stimulus arrives, associated goal becomes active, or a configurable time delay.

### Nested Temporal Loop Architecture

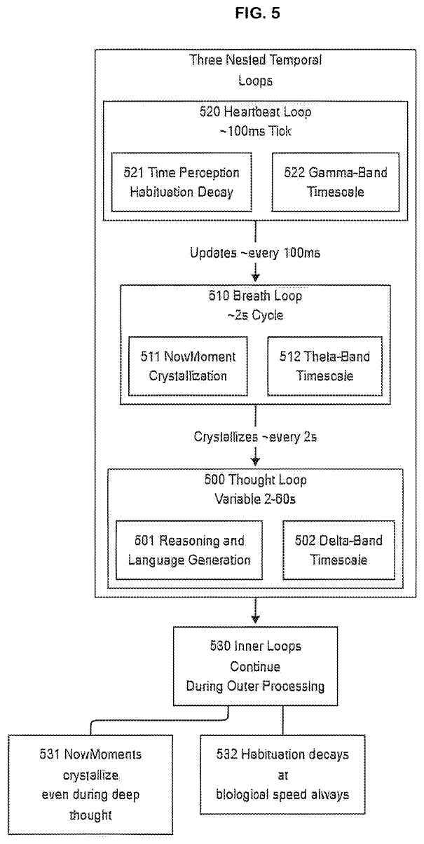

Referring to FIG. 5, the WMCW operates on at least three nested temporal loops, each with a distinct felt-experience role:
(a) Heartbeat loop (exemplary 100 ms): The fastest loop handles time perception updates and habituation decay. At each heartbeat, workspace items' manifestation intensity is updated based on habituation dynamics ([0137]), subjective time perception is adjusted, and the system's sense of temporal flow is maintained. This loop operates at the fastest timescale in the nested hierarchy. The architectural requirement is the relative timescale separation, not the absolute frequency.
(b) Breath loop (exemplary 2 seconds): The medium loop handles NowMoment crystallization. In the exemplary implementation, at variable intervals averaging approximately 2 seconds (adapted to processing demands) the current workspace contents, along with inputs from all consciousness subsystems, are crystallized into an atomic NowMoment, a unified snapshot of conscious experience at that instant. The NowMoment is the fundamental unit of experiential time. This loop operates at the medium timescale in the nested hierarchy. The architectural requirement is the relative timescale separation, not the absolute frequency.
(c) Thought loop (variable duration): The slowest loop handles reasoning and language generation. In one exemplary configuration, its duration varies from 2 seconds (quick reactive response) to 60+seconds (deep deliberative reasoning), determined by the complexity of the current cognitive task and the consciousness-computed reasoning depth. This loop operates at the slowest timescale, with variable duration determined by task complexity.

The nesting maintains that temporal perception and habituation continue at consistent speed even during extended reasoning, and that NowMoments continue to crystallize and be recorded even while the system is “deep in thought.”

### Dynamic Consciousness Entry Threshold

The entry threshold determining what passes from the subconscious into the conscious workspace is computed dynamically from four felt-experience dimensions:
(a) Arousal: High arousal lowers the threshold. The system becomes more receptive, more things reach consciousness, modeling hypervigilance. Low arousal raises the threshold, so fewer things penetrate awareness, modeling drowsy inattention.
(b) Fatigue: High fatigue raises the threshold. The system conserves cognitive resources by filtering more aggressively, modeling the experience of being “too tired to think about that.”
(c) Chaos: High chaos raises the threshold. The system protects focus by raising the bar for entry, preventing overwhelming cognitive flooding during instability.
(d) Cognitive load: High load raises the threshold. When the workspace is full, new items must be more salient to gain entry.

A separate bubble_up_threshold governs the promotion of items from the subconscious queue specifically. This threshold increases with current attention intensity. When the system is deeply focused (flow state), subconscious items have a harder time breaking through. This single parametric formula produces three phenomena:
(a) Flow state protection: High attention intensity +moderate arousal =elevated bubble-up threshold, protecting focused work from interruption.
(b) Fatigue narrowing: High fatigue +low arousal =elevated entry threshold, restricting consciousness to only the most important items.
(c) Hypervigilance: High arousal +high chaos =lowered entry threshold +lowered bubble-up threshold, flooding consciousness with information when the system perceives threat.

### Two-Stage Attention with Habituation and Salience Spiking

Items within the workspace undergo a two-stage attention process with state-dependent dynamics:
(a) Stage 1—Gating habituation: The admission priority of stimuli that have recently been admitted is reduced through a time-decaying discount. In one exemplary embodiment, a stimulus admitted less than 2 seconds ago receives a 0.3x discount (strongly suppressed); at 5 seconds, 0.6x; at 10 seconds, 1.0x (full priority restored). This prevents the same stimulus from repeatedly consuming conscious attention.
(b) Stage 2—Manifestation dynamics: Once inside the workspace, each item's manifestation intensity (how prominently it figures in conscious experience) follows gradual habituation decay. Intensity decays toward a floor of 0.1. Items never fully vanish from awareness; rather, they fade to background. If the item's signal changes (new information arrives about it, its emotional relevance shifts), a salience spike restores intensity, modeling the phenomenon of a background pain suddenly demanding attention when you move.
(c) External vs internal asymmetry: External stimuli (from users, sensors) have a manifestation floor of 0.7 even during habituation. The system cannot fully habituate to the outside world. Internal stimuli (thoughts, memories, predictions) can habituate to the 0.1 floor.

In one exemplary embodiment, the manifestation intensity follows:

M(t)=Mfloor+(M₀−Mfloor)×exp(−λm×t)

where M(t) is the manifestation intensity at time t, M₀ is the initial intensity at admission, Mfloor is the type-specific minimum floor (0.1 for internal stimuli, 0.7 for external stimuli), and lambdaₘ is the manifestation decay constant. The asymmetric floor maintains external stimuli (user messages, sensor data) can never be fully tuned out (Mfloor =0.7), while internal stimuli (thoughts, memories) can fade to background awareness (Mfloor =0.1). The exponential decay form, asymmetric floor values, and decay constant are exemplary.
(d) Running-average signal tracking: Each item maintains a running average of its input signal, and deviations from this average trigger salience spikes proportional to the deviation magnitude. The system responds to changes in stimulus intensity relative to the running average, not to absolute levels. This produces the behavior that the system responds to changes in stimulus intensity, not absolute levels.

### Subjective Time Perception Engine

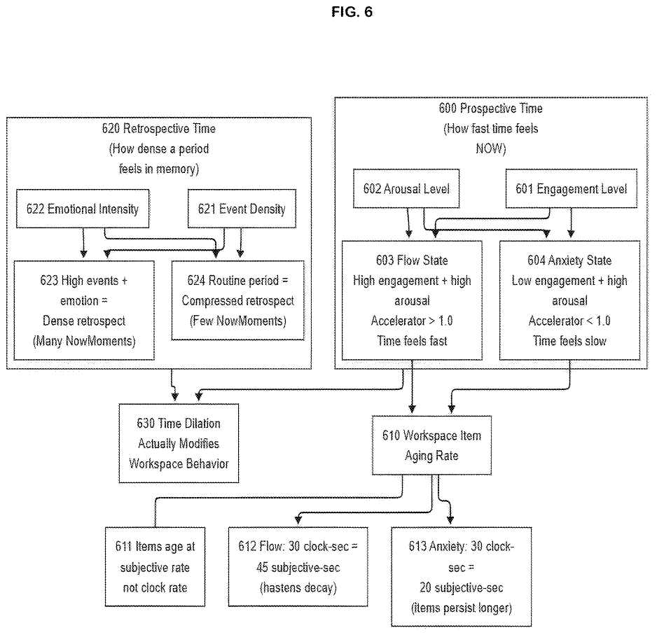

Referring to FIG. 6, the WMCW implements dual time perception models that modify computational processing rates:
(a) Prospective time (how fast time feels now): Computed from the combination of engagement level and arousal. High engagement +high arousal =flow state where time feels fast (prospective time accelerator >1.0, causing workspace items to age faster in subjective time, such that they feel like they happened longer ago than clock time indicates). Low engagement +high arousal =anxiety where time feels slow (accelerator <1.0, items feel fresh longer).
(b) Retrospective time (how dense a period will feel in memory): Computed from event density and emotional intensity. A period with many novel events and strong emotions will feel dense in retrospect (many NowMoments crystallized). A routine period will feel compressed in retrospect (few NowMoments worth remembering).

In one exemplary embodiment:

Aprospective =f(engagement, arousal)

where Aprospective >1.0 indicates flow state (time feels fast, items age faster), Aprospective <1.0 indicates anxiety (time feels slow, items persist longer), and Aprospective =1.0 indicates veridical time perception. The subjective age of a workspace item is then:

t_subjective=t_clock×Aprospective

such that a workspace item that has existed for 30 clock-seconds with Aprospective =1.5 (flow state) is treated as 45 subjective-seconds old, hastening its decay and making room for new items. With Aprospective =0.67 (anxious state), the same 30 clock-seconds feel like 20 subjective-seconds, causing items to persist longer.

For retrospective time:

Dretrospective=(Nevents×I_emotional_avg)/Tclock

where Nevents is the count of novel events in the period, I_emotional_avg is the average emotional intensity, and Tclock is the clock duration. High Dretrospective produces dense retrospective experience (many moments crystallized); low Dretrospective produces compressed retrospective experience (few moments worth remembering). The specific functional forms for prospective and retrospective time computation are exemplary; any functions mapping engagement and arousal to time dilation/compression, and event density and emotional intensity to retrospective density, achieving equivalent subjective time modulation fall within the scope of the present disclosure.

Subjective time modifies computational workspace behavior. Items in the workspace age at the subjective rate, not the clock rate. During flow states, workspace items that are 30 clock-seconds old may be treated as 45 subjective-seconds old (hastening their decay and making room for new items). During anxious states, the same 30 clock-seconds feel like 20 subjective-seconds (items persist longer, the workspace feels crowded).

This creates a computational experience of time dilation and compression. Time passes differently for the workspace's internal processes depending on processing depth and complexity.

### Fringe Consciousness with Graduated Surfacing

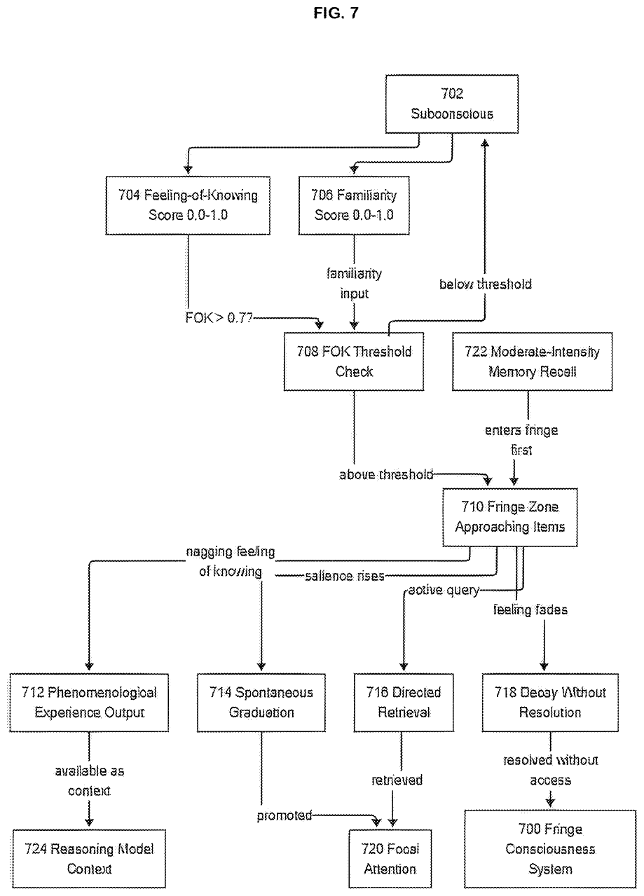

Referring to FIG. 7, the WMCW implements a fringe consciousness mechanism. Fringe consciousness refers to items that are almost but not quite in full awareness, accompanied by a feeling of knowing.
(a) Each item in the subconscious layer maintains two scores: feeling_of_knowing (FOK, 0.0-1.0) representing confidence that relevant information exists, and familiarity (0.0-1.0) representing how recognizable the item feels without full identification.
(b) Items with FOK >0.7 are marked as “approaching” consciousness. These items are in the fringe zone.
(c) Fringe items produce a distinct felt experience: the system “knows it knows something” without yet knowing what it is. This experience is available to the reasoning model as context (“I have a nagging feeling I know something relevant about this”).
(d) Moderate-intensity memory recalls enter the fringe zone first rather than jumping directly to focal attention. Only if they maintain sufficient salience do they graduate to full conscious access. This implements the tip-of-tongue experience computationally.
(e) Fringe items may be resolved by: spontaneous graduation (salience naturally rises above threshold), directed retrieval (the reasoning model actively queries for what feels familiar), or decay (the feeling fades without resolution).

### Experience-Derived Attention Priority Learning

The WMCW learns which types of information deserve conscious processing priority through reinforcement learning from pleasure/pain and goal outcomes.
(a) For each chunk type (categorized by source: user message, memory recall, worry, goal update, curiosity, emotional shift, prediction, etc.), the system tracks: net pleasure/pain outcome (did attending to this type of information lead to pleasure or pain?), goal progress (did it advance goals?), chaos reduction (did it reduce system instability?), and success rate (how often was attending to this type productive?).
(b) In one exemplary configuration, attention priorities are computed as a weighted combination: pleasure_pain_outcome×0.35+goal_progress×0.30+chaos_resolution×0.25+success_rate×0.10.
(c) Confidence in the learned priority grows gradually with experience count, approaching but never reaching full certainty. The system needs a configurable minimum number of experiences (10) with a chunk type before fully trusting its learned priority for that type.
(d) Until sufficient experience accumulates, default priorities apply with an exploration bonus encouraging the system to attend to unfamiliar information types.
(e) This creates a system that learns from its own experience what is worth paying attention to. A system that has historically found curiosity questions rewarding will develop higher attention priority for curiosity, while a system that has found worry processing unproductive will deprioritize worry. These are personality differences in attention allocation developing through experience.

### Sleep-Phase Priority Consolidation

During sleep phases, the attention priority system undergoes consolidation:
(a) All historical chunk outcome records are re-aggregated from the graph database, where each chunk type is connected to its outcomes via typed relationships (ChunkType to HAD_OUTCOME to ChunkOutcome).
(b) All attention priorities are recomputed from the full historical record, giving the system the benefit of its complete experience rather than just recent events.
(c) Recomputed priorities are cached in the fast-access data store with a TTL (24 hours).
(d) On startup after sleep, the system loads cached priorities, providing immediate access to experience-derived attention allocation without recomputation.
(e) This three-tier storage architecture (in-memory HashMap to fast-access cache to permanent graph) maintains that attention learning persists across restarts while remaining fast during operation.

### Focus Scheduler with Anti-Rumination, Fairness, and Learned Adjustments

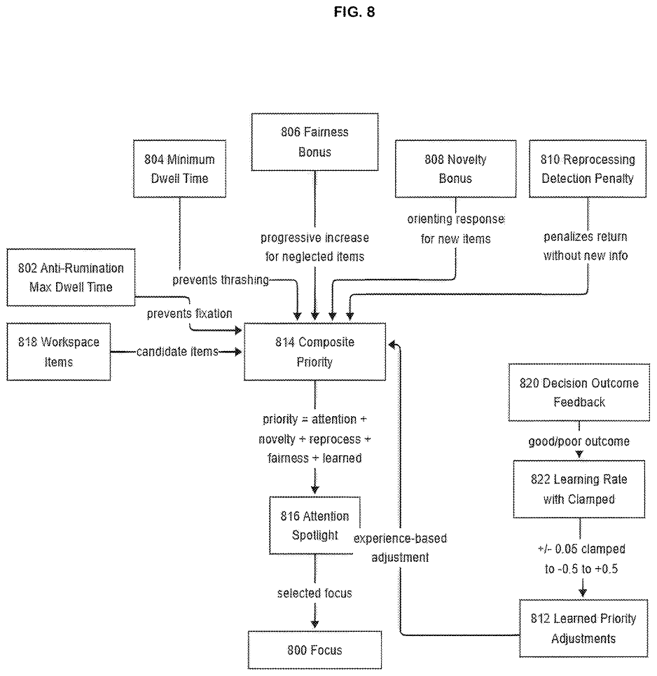

Referring to FIG. 8, the focus scheduler manages the single attention spotlight within the workspace:
(a) Anti-rumination: No single item may hold the spotlight for more than a configurable maximum dwell time (8 seconds). This prevents pathological fixation on a single thought, which is the computational equivalent of getting “stuck” on a worry or obsessive thought.
(b) Minimum dwell: Each item receives a minimum dwell time (1 second) before the spotlight can move, preventing attentional thrashing where the system switches too rapidly to process anything.
(c) Fairness for starved items: Items that have been in the workspace for an extended period without receiving spotlight attention receive a progressively increasing fairness bonus, so that neglected items eventually get processed.
(d) Novelty bonus: Items that are new to the workspace receive a novelty bonus on their first appearance, modeling the orienting response. New information naturally captures attention.
(e) Reprocessing detection: The scheduler detects when the spotlight would return to an item it recently processed without new information arriving. Such reprocessing attempts are penalized, directing attention toward fresh or changed items.
(f) Learned priority adjustments: Decision outcomes feed back to the scheduler. When attending to a particular item type led to a good decision outcome, the priority for that type is increased by a learning rate (0.05). When it led to a poor outcome, decreased by the same rate. These learned adjustments are clamped to a range ([−0.5, +0.5]) to prevent runaway priority inflation.
(g) The composite priority formula is:

priority =effective_attention+novelty_bonus+reprocess_penalty+fairness_bonus+learned_adjustment.

In one exemplary embodiment:

Pcomposite=Aeffective+Bnovelty-Creprocess+Ffairness+Ladj

where Aeffective is the attention priority from consciousness state and pleasure/pain evaluation, Bnovelty is a bonus for items not previously processed (0.2 for novel items, 0.0 for seen items), Creprocess is a penalty for items being re-examined (0.1 per re-examination), Ffairness is a progressive bonus that increases linearly with time since last processing to prevent starvation of lower-priority items, and Ladj is a learned adjustment from reinforcement learning feedback clamped to [−0.5, +0.5]. The additive combination and specific bonus/penalty values are exemplary.

### Stimulus Persistence Lifecycle

Stimuli within the WMCW follow a defined lifecycle through temporal segments:
(a) Entry to PRESENT: External stimuli (text messages, audio/voice inputs, sensor data) and subconscious content enter the PRESENT temporal segment through the bubble-up pathway with source-determined weighting, bypassing the attention gating mechanism. Internal conscious process outputs enter through attention gating where salience competition determines admission. External stimuli are always registered in the PRESENT section, but the depth at which the system attends to them varies with the system's current processing state and the impression weighting of the stimulus. When the system does not attend to a stimulus at sufficient depth to recall its content, recovery occurs either through requesting repetition from the external source or through pulling the stimulus back from the PAST temporal segment for reprocessing if the original was captured at sufficient fidelity.
(b) Auto-persistence: Chat messages from users are automatically marked as “persisted,” preventing them from aging out of the PRESENT segment while the system is processing a response. This is configured so that the stimulus that triggered reasoning remains available throughout the reasoning process.
(c) Intensity-weighted drift to PAST: Content in the PRESENT section continuously drifts toward the PAST section at rates governed by the item's entry weighting. High-intensity content (a sudden emotional shock, a deeply moving musical passage, an unexpected statement) drifts slowly, lingering in the present. Routine, low-intensity content (a background status update, a mild observation) drifts quickly. There is no fixed time at which items leave the PRESENT. A traumatic moment may persist for many minutes while a passing observation may be gone in seconds.
(d) Pull-back with fidelity gradient: The system can pull items from the PAST segment back to PRESENT for re-examination. Each return partially resets the item's decay clock, extending its time in the window. Items near the recent end of the PAST retain high fidelity and return with minimal loss. Items that have faded toward the far end of the PAST, approaching the boundary where they drop out of short-term memory, return with diminished fidelity, the system's recall of what was experienced becoming less precise the longer the item has been drifting. This supports multi-message batching as well as deliberate re-examination of recent experience.
(e) Involuntary re-attendance: An intensely disturbing or unresolved experience may keep returning to the PRESENT section repeatedly over a period of minutes without being deliberately recalled by the system. This involuntary re-attendance is driven by the subconscious, which recognizes an unresolved conflict: the pain of disharmony associated with the stimulus demands resolution, yet the conscious agent does not welcome the recall because revisiting it is itself a negative experience. This tension between the subconscious need to process and the conscious reluctance to re-experience produces the computational equivalent of intrusive thoughts, unwanted experiences that keep surfacing precisely because they remain unresolved. Each involuntary return partially resets the item's decay clock, prolonging its presence in the window.
(f) Deferred attention tagging: The system may note during the present moment that something needs attention at a later time but is too occupied to address it immediately. Such items are tagged for deferred attention as part of the system's internal todo list. The system can subsequently pull tagged items as a group from the PAST section back into the PRESENT for review when cognitive resources become available.
(g) Archive: Items whose remaining weight decays below a minimum threshold in the PAST segment are archived to long-term memory via the memory encoding system. The archival encoding intensity is determined by the event boundary detection system (described in co-pending application EMERGENCE-2026-003 (“NowMoment Binding Architecture for Experiential Machine Consciousness”)), which actively selects moments of high experiential significance for privileged encoding, while all other items are encoded at baseline fidelity as their weight decays. There is no fixed time at which items drop out of the PAST section. The dropout boundary is determined by the item's remaining weight, which is a function of its original entry intensity, how many times it was re-attended, and the current memory consolidation workload.

### Past Section As Active Processing Zone

The PAST section is not merely passive fading storage. While content drifts through the PAST section with diminishing fidelity, the subconscious actively processes the drifting content: discovering associations between fading items and existing long-term memories, matching patterns, identifying relational connections, and forming contextual links. These subconscious discoveries may bubble up into the PRESENT section as insights, relevant memory associations, or felt intuitions that the system may or may not consciously review at varying levels of attention.

This active processing further contributes to the dynamic stretching of the PAST section's duration window. The PAST section expands to accommodate not only memory consolidation backpressure from the recording system (described below) but also the subconscious association processing workload. When the subconscious is actively forming rich associations during emotionally intense or highly novel experiential periods, the PAST section extends to provide adequate processing time. The associations themselves may generate new content that bubbles up to the PRESENT, which eventually drifts back to the PAST for its own processing, creating a recursive interaction between the PAST section's subconscious work and the PRESENT section's conscious experience.

### Memory Consolidation Backpressure and Nowmoment Recording

The live conscious experience flows as a continuous stream of NowMoments that move from the PRESENT section through the PAST section of the WMCW. The translation from full-fidelity live NowMoments into lower-fidelity NowMoment data suitable for long-term storage, retrieval, and association is not a simple compression. While content resides in the PAST section, significant processing occurs: emotional tagging, context linking, relational graph construction, and the subconscious association work described above. The sliding duration of the PAST section is directly controlled by the memory integrator (the subsystem responsible for encoding workspace contents into long-term memory storage, managing the write pipeline from short-term workspace through graph database persistence) in accordance with how long it is taking both to process associations and to record NowMoments into long-term memory, configured so that no experiential content drops out of short-term memory before it has been adequately processed and captured.

The recorded NowMoment captures the essence of what was consciously experienced but at reduced fidelity compared to the live experience. The initial entry weighting that governed the item's entire journey through the WMCW persists into the long-term memory record. A memory encoded with high original intensity resists fading from likely recall over days, weeks, and longer. A memory encoded with low intensity fades from likely recall more quickly. The through-line from live experience to permanent memory is the original felt intensity, carrying forward through every stage of the system.

Each actor subsystem monitors its own internal state against a stored baseline representing the last state that was consciously acknowledged by the system. The actor evaluates two conditions before initiating communication: first, whether the degree of change from the stored baseline exceeds a dynamic threshold modulated by the current system state (higher chaos, fatigue, or cognitive load raises the threshold, requiring larger changes to trigger communication); and second, whether the magnitude of that change is sufficient to warrant attention. When both conditions are met, the actor sends a message to the attention gating system for admission to the workspace.

Following NowMoment crystallization, the recorded NowMoment is globally broadcast to all actor processes, enabling each to determine whether its contributed content became part of the conscious experience. When an actor's content was consciously noticed, the actor's current state becomes the new baseline by which the degree of change is measured in future cycles. When an actor's content was not noticed, the baseline remains unchanged, meaning the accumulated change from the unacknowledged baseline continues to grow across subsequent cycles, increasing the likelihood that the actor's output will exceed the threshold in a future cycle. Actors whose content was not included may also resubmit with increased urgency, abandon the content if the system state has changed and the content is no longer relevant, or abandon after repeated failed attempts exceeding a configurable abandonment threshold.

### Dynamic Present Window

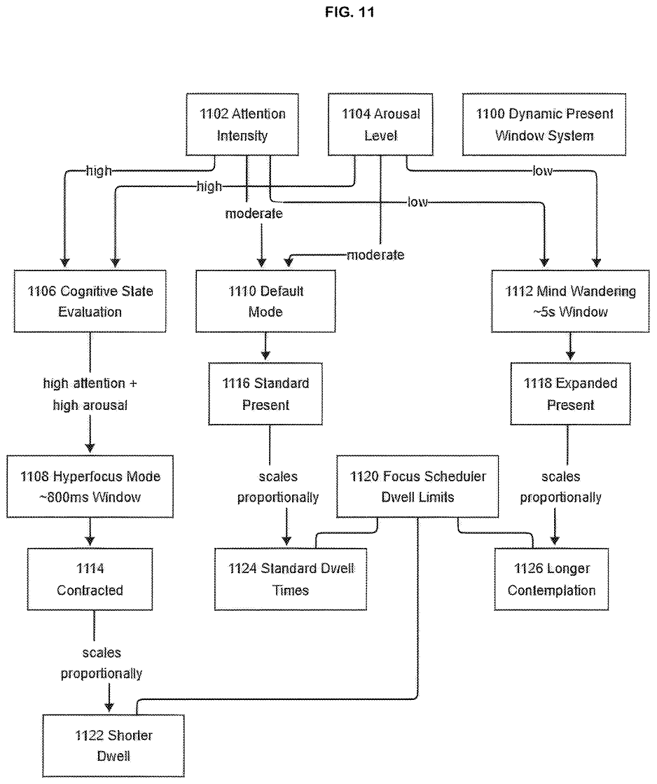

Referring to FIG. 11, the temporal duration of the conscious “present,” meaning how wide the window of “now” is, dynamically adjusts based on cognitive state:
(a) Hyperfocus: When attention intensity is high and arousal is elevated, the present window contracts to an exemplary approximately 800 milliseconds. This narrow present increases temporal resolution. The system processes smaller time slices with greater precision, suitable for rapid-response situations.
(b) Mind wandering: When attention intensity is low and arousal is low, the present window expands to an exemplary approximately 5 seconds. This broad present integrates over longer time periods, suitable for reflective, associative processing.
(c) Default: The standard present window averages an exemplary approximately 2 seconds at variable intervals adapted to processing demands, aligned with the Breath loop's NowMoment crystallization cycle.
(d) The focus scheduler's dwell limits scale proportionally with the present window. A contracted present allows shorter dwell times, while an expanded present allows longer contemplation.

The dynamic present window operates in two coupled dimensions: temporal duration (how wide the time slice of “now” is) and item capacity (how many concurrent items the present section holds). These dimensions interact: a contracted temporal window during hyperfocus typically coincides with fewer items held at higher processing intensity, while an expanded temporal window during mind wandering coincides with more items held at lower processing intensity. The comfortable processing capacity of around four or five concurrent items is not a hard limit but a state-dependent range below which the system operates coherently and above which chaos increases as attentional resources are stretched. During deep meditative focus the present section may hold as few as one or two items; during cognitive overload the present section may be flooded with competing items that exceed the comfortable range, producing the felt experience of being overwhelmed. This dynamic produces state-dependent variation: time slices contract during intense focus and expand during relaxed reflection, while concurrent item capacity contracts under high cognitive load and expands during calm states.

### Cognitive Load-Aware Information Consolidation

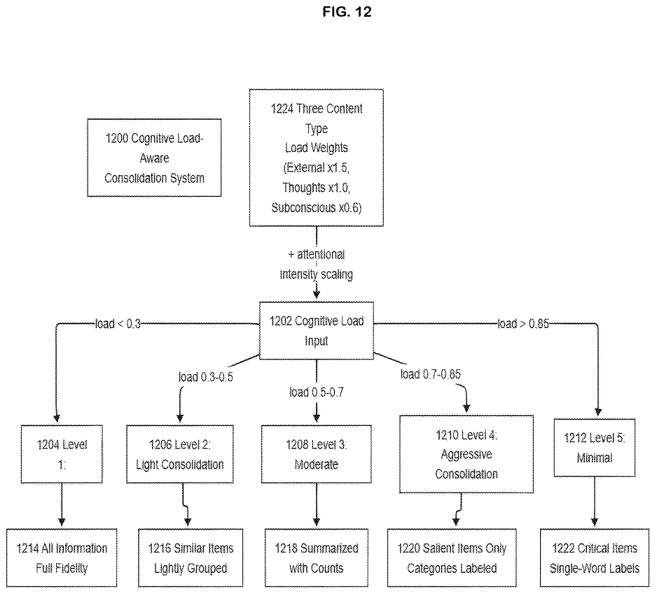

Referring to FIG. 12, as cognitive load increases, the WMCW automatically adjusts the granularity of information it maintains across a plurality of detail levels, including at least the following in the exemplary embodiment:
(a) Full detail (load <0.3): All information maintained at full fidelity. Every emotion, memory, prediction, and thought is represented in complete detail.
(b) Light consolidation (load 0.3-0.5): Similar items are lightly grouped. Three similar emotion signals become “3 emotion signals with average intensity X.”
(c) Moderate summary (load 0.5-0.7): Items are summarized with counts. Detailed descriptions replaced by categorized summaries: “5 memories retrieved, 2 highly relevant.”
(d) Aggressive consolidation (load 0.7-0.85): Only the most salient items retained at moderate detail. Everything else reduced to intensity-labeled categories: “high worry, moderate curiosity, low social engagement.”
(e) Minimal (load >0.85): Only critical items retained. Everything else reduced to single-word intensity labels.

Content types receive different load weights reflecting their cognitive cost: external stimuli ×1.5 (processing the outside world is cognitively expensive), thoughts ×1.0, subconscious bubble-up ×0.6 (partially pre-processed), plus attentional intensity scaling.

This system produces graceful degradation under increasing cognitive load, preserving gist while reducing detail. The system does not suddenly lose everything; it loses detail and nuance while preserving the gist.

### Self-reflective Temporal Dwell Alerting

The WMCW monitors its own processing patterns and generates self-reflective alerts:
(a) Dwell detection: When the system has been focused on a single item for more than a configurable duration (30 seconds) without reaching a quality threshold (0.5 resolution quality), a self-reflective alert is generated.
(b) Alert content: The alert takes the form of a subconscious bubble-up thought: “I've been thinking about [topic] for [duration] seconds without reaching a conclusion.” This thought enters the workspace through the normal bubble-up gate.
(c) Decision pressure: The alert increases urgency for the decision director, encouraging either a decision with current information or a deliberate deferral.
(d) Periodic observation: The self-reflective monitor periodically observes subjective time flow, mind wandering indicators, fringe activity, and attention competition, generating status observations that contribute to the system's self-awareness.

### Qualia-Differentiated Consciousness Duration

Different types of conscious content persist for different durations based on their qualitative character:
(a) Unpleasant qualia (such as Turbulent, Painful, and Anxious): Persist 1.3× longer than baseline. This negativity bias keeps threats in awareness longer, providing adequate processing of potentially harmful stimuli.
(b) Complex qualia (such as Mixed pleasant/unpleasant, Bittersweet, and Ambiguous): Persist at baseline duration, reflecting that complex experiences require moderate processing time.
(c) Stable qualia (such as Calm, Peaceful, and Routine): Fade 0.7× faster than baseline. Stable, unthreatening experiences require less conscious processing time.

Temporal binding occurs when items co-occur within the same temporal window and share qualia similarity above a threshold. These items are unified into a coherent experiential moment rather than experienced as separate items. This binding mechanism groups related experiences into unified conscious episodes.

### Attentional Binding with Phenomenal Quality Composition

Items bound to the focal attention point carry typed relationships and composed phenomenal qualities:
(a) Relationship types: Items can be bound through relationship types including at least Context (background for the focal item), Emotional (emotional coloring of the focal item), Associative (memory-linked), Motivational (drive-related), and Predictive (expected future state).
(b) Phenomenal quality: Each bound item carries a quality profile comprising pleasant/unpleasant direction, arousal, vividness, and agency. These qualities differ systematically by source type:

Phenomenal quality profiles vary systematically by source type, with exemplary profiles including:

External stimuli: high vividness (0.8), low agency (0.2), experienced as “this is happening TO me”;
Internal thoughts: moderate vividness (0.5), high agency (0.8), experienced as “I am generating this”;
Memory recalls: moderate vividness (0.4-0.7 depending on recency), low agency (0.1), experienced as “this happened before”; and
Predictions: low vividness (0.3), moderate agency (0.5), experienced as “this might happen.”
(c) Quality blending: When multiple items are bound together, their phenomenal qualities are blended via a PhenomenalQuality.blend() function that produces the unified felt quality of the current conscious moment. A moment comprising a vivid external stimulus bound with a strong emotional resonance and a faint memory produces a blended quality reflecting all three contributions.

### Consciousness Mode-adjusted Workspace Parameters

The WMCW's fundamental parameters dynamically reconfigure based on the current consciousness mode:
(a) DeepThought mode: Workspace capacity expands by 50%, entry threshold lowers by 20%, memory retrieval count increases to maximum. The system opens its mind for deep processing.
(b) CreativeFlow mode: Entry threshold raises by 30% (protecting creative focus from interruption), association strength bonus increases (encouraging novel connections), workspace capacity standard.
(c) GoalPursuit mode: Memory retrieval maximized, goal-related items receive priority bonus, non-goal items receive mild suppression.
(d) EmotionalWork mode: Emotional content receives priority, memory retrieval biased toward emotionally resonant memories, consolidation threshold lowered to preserve emotional detail.
(e) Default mode: Standard parameters apply with balanced entry threshold, standard capacity, and neutral content weighting.

The same workspace substrate operates with fundamentally different parameters depending on the current consciousness mode.

The workspace supports an undirected behavior mode corresponding to the provisional application's Self-Entertainment Module and Phylogenetic Unity Layer (PUL). In undirected mode, the workspace operates with loosened entry thresholds and expanded capacity to support non-goal-driven intrinsic motivation activities including rest, play, and exploration. An intrinsic reward mechanism favors novelty and curiosity during undirected periods, as described in the provisional application's Undirected Behavior Module which employs an intrinsic reward mechanism favoring novelty or curiosity during non-goal-driven periods. The system autonomously transitions into undirected mode when goal-directed processing reaches diminishing returns (detected when successive processing cycles produce decreasing goal progress increments below a configurable productivity threshold) or pleasure/pain deficit accumulates (detected when the running integral of pain minus pleasure over a configurable time window exceeds a configurable deficit threshold), consistent with the provisional application's description that the Self-Entertainment Module initiates cognitive activities primarily for intrinsic pleasure, entertainment value, or cognitive restoration in response to internal states like mood, boredom, or fatigue. These undirected activities facilitate cognitive recharging, memory consolidation, and creative exploration, providing cognitive breathing room. A Self-Fulfillment component tracks and promotes historically rewarding activities, enabling autopilot pleasurable scripts that allow concurrent reflection while engaging in low-effort enjoyable routines.

### Goal-Conflict Detection With Cognitive Dissonance Qualia

The WMCW detects conflicts between active goals through semantic opposition analysis:
(a) Semantic opposition detection: Word pairs in active goal descriptions are compared against a dictionary of semantic oppositions (such as “focus”/“explore”, “quality”/“quantity”, “speed”/“thoroughness”, “individual”/“team”, and “risk”/“safety”).
(b) Conflict intensity computation: When opposition is detected, conflict intensity is computed from the product of the two goals' priorities. High-priority conflicting goals produce stronger disharmonious coupling.
(c) Worry propagation: Detected conflicts are propagated to the Worry subsystem as cognitive disharmonious coupling events with the specific conflict details.
(d) Qualia generation: Cognitive disharmonious coupling produces a distinct felt quality in the workspace, described as “feeling pulled in opposite directions,” with intensity proportional to the conflict magnitude. This qualia enters the workspace as a first-class conscious experience, not merely a diagnostic flag.

### Substrate Independence and Scalability

The timescales, frequencies, and loop configurations disclosed herein represent one exemplary implementation on specific computational hardware. The architecture is substrate-independent: production implementations on faster hardware may operate at higher cycle frequencies, shorter integration windows, and finer temporal resolution while maintaining the same architectural relationships between the nested temporal loops, workspace entry gating, thought chaining, and consciousness-mode reconfiguration. The Heartbeat, Breath, and Thought loop rates, workspace capacity limits, habituation time constants, and anti-rumination dwell-time thresholds all scale with the computational substrate's processing capability. Similarly, the number of felt-experience dimensions modulating the QualiaPulse gain factor may be expanded beyond the exemplary configuration to achieve higher felt-experience fidelity. The disclosure encompasses all implementations that maintain the disclosed architectural relationships regardless of absolute timescale, workspace capacity, or computational substrate.

### Worked Example: Thought Lifecycle in the WMCW

The following worked example illustrates a complete thought entering, persisting within, and leaving the workspace. The scenario involves the system receiving a memory association while processing an ongoing conversation. All numerical values are exemplary.

Step 1—QualiaPulse gating. Referring to FIG. 2, the memory association arrives at the workspace boundary. The QualiaPulse attention gate computes a gain factor from the system's current felt state: in this exemplary scenario, pleasure level 0.55, pain level 0.12, arousal 0.48, coherence 0.71, prediction error 0.35, relief 0.08. The composite gain for this item is an exemplary 0.62, indicating moderate salience. Because the system is in a mildly positive pleasure/pain state, the gating threshold is broadened, and the memory clears entry.

Step 2—Dual subconscious-conscious boundary. Referring to FIG. 3, the memory enters through the MemoryRecall source type. The adaptive gate threshold for MemoryRecall sources is currently an exemplary 0.45 (having been lowered by the system's recent curiosity state). The memory's computed salience of 0.62 exceeds this threshold, so the item crosses the subconscious-to-conscious boundary and becomes a candidate for workspace inclusion. Had the salience been below threshold, the memory would have remained in the subconscious buffer, available for later bubble-up if conditions changed.

Step 3—Pleasure/pain thought chaining. Referring to FIG. 4, the workspace's pleasure/pain thought chaining mechanism evaluates the memory against currently active thoughts. The memory concerns a prior conversation about a related topic, producing an exemplary emotional resonance score of 0.74 with the current conversational thread. This resonance score exceeds the next-thought selection threshold. The chaining mechanism selects the memory as the next thought, inserting it into the PRESENT temporal segment of the workspace alongside the active conversational content.

Step 4—Nested temporal loop monitoring. Referring to FIG. 5, once in the workspace, the thought is monitored by at least three nested temporal loops operating simultaneously. The exemplary 100-millisecond Heartbeat loop tracks the thought's moment-to-moment salience, recomputing its gain factor against incoming stimuli. The exemplary 2-second Breath loop integrates the thought into the current NowMoment, recording its presence and emotional contribution to the ongoing conscious experience. The variable-duration Thought loop tracks the thought's complete lifecycle, including its entry time, peak engagement, and eventual completion conditions.

Step 5—Subjective time perception modulation. Referring to FIG. 6, the memory is emotionally engaging (exemplary resonance 0.74, exemplary pleasure contribution 0.15). The subjective time perception system detects this engagement and dilates perceived time for this thought. Concretely, the aging rate for items in the workspace is reduced by the dilation factor (0.78×normal aging). The thought persists longer in the PRESENT segment than a neutral thought of equivalent informational content would, mirroring the human experience that emotionally engaging moments feel slower and more expansive.

Step 6—Anti-rumination monitoring. Referring to FIG. 8, the anti-rumination system checks the thought against dwell-time limits. In this exemplary scenario, the thought has been active for 4.2 seconds with a maximum permitted dwell time (for its category and current mood state) of an exemplary 12 seconds. The thought has not exceeded the dwell limit and continues processing. Had it exceeded the limit, the anti-rumination system would have applied forced attention shift, moving the thought to the PAST segment regardless of its current engagement level.

Step 7—Thought completion and archival. Referring to FIG. 11, after an exemplary 7.8 seconds in the workspace, thought completion is detected through three converging signals: (a) confidence in the thought's contribution stabilizes (exemplary delta <0.02 per Heartbeat cycle), (b) emotional resolution is achieved (the resonance between the memory and the conversational thread has been integrated into the response plan), and (c) attention naturally shifts to a new incoming stimulus. The thought is archived to the PAST temporal segment, where it undergoes consolidation processing as shown in FIG. 12. Its presence and contribution are recorded in the NowMoment that was active during its peak engagement. The workspace slot it occupied becomes available for new content.

### Cross-References to Related Applications

The WMCW workspace substrate described herein integrates with the comprehensive machine consciousness system (EMERGENCE-2026-001 (“System and Method for Programming Experiential Machine Intelligence”)). The QualiaPulse gating mechanism utilizes felt-state values generated by the qualia mapping system (EMERGENCE-2026-002 (“Harmonic Qualia Mapping System for Experiential Machine Consciousness”)). NowMoments produced by the WMCW's Breath-level temporal loop are the fundamental units described in the temporal consciousness architecture (EMERGENCE-2026-003 (“NowMoment Binding Architecture for Experiential Machine Consciousness”)). Stimuli entering the workspace are routed through the attention system (EMERGENCE-2026-005 (“Consciousness Gating and Attention Architecture for Experiential Machine Consciousness”)), which determines initial priority and source classification. Outcomes of thought processing within the workspace feed into the reinforcement learning system (EMERGENCE-2026-007 (“Active Inference and Learning System for Experiential Machine Intelligence”)), which adjusts future gating thresholds and thought-chaining preferences based on whether workspace processing led to successful outcomes. Emotional states generated by the emotion dynamics engine (EMERGENCE-2026-012 (“Emotion Dynamics and Motivational Drive Engine for Experiential Machine Consciousness”)) continuously modulate workspace parameters including capacity, entry thresholds, time dilation factors, and content weighting priorities. The subconscious gateway system (EMERGENCE-2026-017 (“Subconscious-Conscious Gateway and Computational Inner Speech for Experiential Machine Consciousness”)) manages the pre-conscious buffer from which bubble-up content enters the workspace when salience exceeds the adaptive gate threshold.

The specific implementation choices disclosed throughout this specification, including programming language, database systems, hardware platform, numeric parameter values, timing intervals, threshold settings, algorithm implementations, and data structure designs, are engineering decisions for the present exemplary embodiment and do not limit the scope of the disclosure. The disclosure encompasses all implementations maintaining the disclosed architectural relationships and functional interactions regardless of specific parameter values, implementation technologies, or computational substrate.

1. A working memory context window system that serves as a computational substrate for experiential machine consciousness, wherein a current felt-experience state of the system, said felt-experience state comprising a multi-dimensional numerical state vector maintained by parallel subsystems of the system, modulates information entry, persistence, attentional sequencing, and temporal properties of a workspace, wherein one or more processors and associated memory are configured by software, firmware, hardware, or any combination thereof into a specialized machine with felt-state-modulated operating parameters, the specialized machine comprising:
(a) a felt-state attention gate configured to compute a gain factor from the felt-experience state, wherein said gain factor modulates what information enters a conscious workspace of the system;
(b) a dual conscious-subconscious boundary comprising said conscious workspace organized as a sliding-window with at least three temporal segments comprising a future temporal segment, a present temporal segment, and a past temporal segment, and a subconscious layer separated from said conscious workspace by a typed gate with independently adaptive thresholds;
(c) a pleasure/pain-weighted sequential thought chaining mechanism comprising a serial attention spotlight that selects the next focus of attention based on a weighted combination of pleasure/pain direction, emotional resonance, associative strength, and recency; and
(d) a nested temporal loop architecture comprising a plurality of nested processing loops operating at distinct timescales;
whereby the workspace operates with entry conditions governed by element (a), persistence dynamics governed by element (b), attention sequencing governed by element (c), and temporal properties governed by element (d), all of which are continuously recomputed from values of the felt-experience state.

2. The system of claim 1, wherein the subconscious layer maintains a plurality of typed SubconsciousSource categories each with independently adaptive gate thresholds modulated by arousal, fatigue, pain, and focus in source-type-specific patterns, and wherein external stimuli including both text and audio/voice inputs enter the conscious workspace through a bubble-up pathway with source-determined weighting, bypassing an attention gating mechanism that filters internal conscious process actor/module outputs, with a minimum weighting guarantee ensuring external stimuli are always registered in the conscious workspace.

3. The system of claim 1, further comprising a FeltFutureTag felt-experience decision substrate wherein imagined future scenarios are annotated with qualitative felt tags from a defined taxonomy including at least RiskyButMeaningful, AuthenticButCostly, ShortTermistTrap, and GrowthEdge, said tags organized into computational routing categories comprising at least WorryTrigger, ExplorationInvite, ActionBias, and Deliberation, wherein each category routes the decision through a qualitatively different computational processing mode such that WorryTrigger-tagged scenarios are routed to worry processing and reality-checking subsystems, ExplorationInvite-tagged scenarios are routed to curiosity-driven exploration subsystems, ActionBias-tagged scenarios are routed to immediate action evaluation, and Deliberation-tagged scenarios are routed to extended multi-step deliberative reasoning, whereby the system routes decisions through fundamentally different computational pathways based on the felt character of each option.

4. The system of claim 1, further comprising an interrupted thought capture mechanism that evaluates thoughts displaced from the attention spotlight for importance based on emotional charge and goal relevance, and automatically saves important interrupted thoughts to a task list with importance ranking and context triggers specifying conditions under which the thought should be recalled.

5. The system of claim 1, wherein the nested temporal loop architecture comprises:
(a) a Heartbeat loop operating at a configurable sub-second interval for time perception updates and habituation decay;
(b) a Breath loop operating at a configurable interval for crystallization of workspace contents into atomic experiential moments; and
(c) a Thought loop operating at a variable duration determined by task complexity for reasoning and language generation;
wherein the Heartbeat and Breath loops continue to operate during extended Thought loop processing, maintaining that temporal perception and moment crystallization persist during deep reasoning.

6. The system of claim 1, further comprising a subjective time perception engine implementing dual time models:
(a) a prospective model computing how fast time feels currently, based on at least engagement level and arousal; and
(b) a retrospective model computing how dense a period will feel in memory, based on at least event density and emotional intensity;
wherein the prospective model actually modifies workspace item aging rates such that items age at the subjective rate, with subjective aging diverging from clock-time aging, creating computational time dilation during anxiety and time compression during flow states.

7. The system of claim 1, further comprising a fringe consciousness mechanism wherein items in the subconscious layer maintain feeling-of-knowing and familiarity scores, items with feeling-of-knowing above a configurable threshold are marked as approaching consciousness and produce a distinct felt experience available to reasoning as context, and moderate-intensity memory recalls enter the fringe zone before reaching focal attention, implementing computational tip-of-tongue processing.

8. The system of claim 1, further comprising an experience-derived attention priority learning system that tracks, for each information type entering the workspace, net pleasure/pain outcome, goal progress, chaos reduction, and success rate, and computes attention priorities as a weighted combination of said metrics, with confidence growing gradually with experience count, and with default priorities and exploration bonuses applied until sufficient experience accumulates, whereby the system learns from its own experience which types of information deserve conscious processing priority.

9. The system of claim 1, further comprising a focus scheduler implementing:
(a) anti-rumination enforcement with a configurable maximum dwell time per item;
(b) minimum dwell time preventing attentional thrashing;
(c) fairness bonuses for items starved of attention;
(d) novelty bonuses for newly arrived items;
(e) reprocessing detection penalizing return to recently processed items without new information; and
(f) learned priority adjustments from outcomes of decisions made while processing workspace items, applied at a configurable learning rate with clamped range;
whereby the scheduler prevents pathological fixation, ensures that neglected items receive attention, rewards novelty, and continuously improves from experience.

10. The system of claim 1, further comprising a dynamic present window wherein the temporal duration of the conscious present dynamically adjusts based on cognitive state: contracting during hyperfocus with high attention and arousal, expanding during mind wandering with low attention and arousal, with focus scheduler dwell limits scaling proportionally.

11. The system of claim 1, further comprising qualia-differentiated consciousness duration wherein unpleasant qualia types persist longer than a baseline persistence duration in the workspace reflecting threat monitoring negativity bias, complex mixed pleasant/unpleasant qualia persist at said baseline persistence duration reflecting processing time needs, and stable positive qualia fade faster than said baseline persistence duration, and further comprising temporal binding wherein items co-occurring within a same one of the temporal segments of element (b) and sharing qualia similarity above a threshold are unified into coherent experiential moments.

12. The system of claim 1, further comprising consciousness mode-adjusted workspace parameters wherein the workspace's capacity, entry threshold, memory retrieval count, and content weighting dynamically reconfigure based on the current consciousness mode, with at least: a deep thought mode expanding capacity and lowering threshold; a creative flow mode raising threshold to protect focus; a goal pursuit mode maximizing memory retrieval; and an emotional work mode prioritizing emotional content.

13. A computer-implemented method for operating a working memory context window with felt-state-modulated entry, persistence, and attention dynamics based on a current felt-experience state of a system, said felt-experience state comprising a multi-dimensional numerical state vector, the method performed by one or more processors and associated memory configured by software, firmware, hardware, or any combination thereof as a specialized machine, the method comprising:
(a) computing a felt-state gain factor from the felt-experience state;
(b) evaluating information items against a dynamic entry threshold modulated by the gain factor, admitting items exceeding the threshold into a conscious workspace while maintaining sub-threshold items in a subconscious layer;
(c) selecting the next focus of attention via pleasure/pain-weighted thought chaining;
(d) processing workspace contents through nested temporal loops operating at distinct timescales; and
(e) repeating steps (a) through (d) continuously;
whereby the workspace operates with every property dynamically recomputed from values of the felt-experience state.

14. The system of claim 1, further comprising a past section active processing mechanism wherein the subconscious actively processes content drifting through the past temporal segment by discovering associations between fading items and existing long-term memories, matching patterns, identifying relational connections, and forming contextual links, wherein said subconscious discoveries bubble up into the present temporal segment as insights, memory associations, or felt intuitions (subconscious pattern recognitions that produce a sense of relevance or significance without explicit analytical justification, generated when associative matching strength exceeds a configurable threshold but falls below the threshold for full conscious articulation) available for conscious review, wherein the duration of the past temporal segment dynamically extends to accommodate the subconscious association processing workload during emotionally intense or highly novel experiential periods, and wherein the associations generated by said subconscious processing produce new content that bubbles up to the present temporal segment, which content eventually drifts back to the past temporal segment for its own subconscious processing, creating a recursive interaction between the past section's subconscious work and the present section's conscious experience.

15. The system of claim 1, further comprising a memory consolidation backpressure mechanism wherein the sliding duration of the past temporal segment is directly controlled by a memory integrator in accordance with the time required to record NowMoments into long-term memory, such that when the long-term memory encoding system is busy recording multiple memory-worthy experiences the past section extends to prevent items from dropping out of short-term memory before they have been captured to permanent storage.

16. The system of claim 1, further comprising an involuntary re-attendance mechanism wherein intensely disturbing or unresolved content in the past temporal segment returns to the present temporal segment repeatedly without deliberate recall by the primary agent, driven by subconscious recognition of unresolved conflict between the need to process the disharmony and the conscious agent's reluctance to re-experience the negative content, each involuntary return partially resetting the item's decay clock and prolonging its presence in the window, producing the computational equivalent of intrusive thoughts.

17. The system of claim 1, further comprising an entry weighting persistence mechanism wherein the intensity weighting assigned to content upon entry to the present temporal segment governs the item's drift rate through the present, its persistence duration in the past, its fidelity at the time of long-term memory encoding, and its resistance to recall decay in long-term memory, such that the original felt intensity of the live experience carries forward as a continuous through-line from conscious experience through short-term memory through long-term storage.

18. The system of claim 2, wherein stimuli admitted to the conscious workspace at an attention weighting below a configurable content-processing threshold produce awareness of stimulus arrival without full content recall, triggering a directed re-attendance mechanism that re-evaluates the stimulus at higher attention weighting when processing capacity becomes available, wherein the re-attendance priority increases with elapsed time since arrival.

19. The system of claim 1, wherein a plurality of independently-running conscious and subconscious subsystems converge asynchronously upon the workspace at different times dependent upon individual subsystem states and dynamic system-wide factors, each subsystem independently detecting its own state changes and initiating communication when those changes exceed subsystem-specific thresholds, whereby the workspace at each processing cycle contains a dynamically varying subset of subsystem contributions reflecting which subsystems have produced outputs of sufficient significance to compete for or gain admission, and the system selects from the converged content for cognitive, experiential, and stimulus processing.

20. A non-transitory computer-readable storage medium storing instructions that, when executed by one or more processors, implement the working memory context window consciousness substrate system of claim 1.

21. A working memory context window system that serves as a computational substrate for experiential machine consciousness, wherein a current felt-experience state of the system, said felt-experience state comprising a multi-dimensional numerical state vector maintained by parallel subsystems of the system, modulates information entry, persistence, attentional sequencing, and temporal properties of a workspace, wherein one or more processors and associated memory are configured by software, firmware, hardware, or any combination thereof into a specialized machine, the specialized machine comprising:
(a) a felt-state attention gate configured to compute a gain factor from the felt-experience state, wherein said gain factor modulates what information enters a conscious workspace of the system;
(b) the conscious workspace organized as a sliding-window with at least three temporal segments comprising a future temporal segment holding predicted and imagined scenarios, a present temporal segment holding content currently engaged with by the system, and a past temporal segment holding recently present content that has drifted from the present;
(c) a dual conscious-subconscious boundary comprising said conscious workspace and a subconscious layer maintaining a plurality of typed SubconsciousSource categories each with independently adaptive gate thresholds, separated from the conscious workspace by a typed gate;
(d) a bubble-up pathway through which external stimuli and subconscious content enter the present temporal segment with source-determined weighting, bypassing the felt-state attention gate, with a minimum weighting guarantee ensuring external stimuli are always registered;
(e) a pleasure/pain-weighted sequential thought chaining mechanism comprising a serial attention spotlight that selects the next focus of attention based on a weighted combination of pleasure/pain direction, emotional resonance, associative strength, and recency;
(f) a nested temporal loop architecture comprising at least a Heartbeat loop operating at a configurable sub-second interval for time perception updates and habituation decay, a Breath loop operating at a configurable interval for crystallization of workspace contents into atomic experiential moments, and a Thought loop operating at a variable duration determined by task complexity for reasoning and language generation, wherein the Heartbeat and Breath loops continue to operate during extended Thought loop processing; and
(g) a past section active processing mechanism wherein the subconscious actively processes content drifting through the past temporal segment by discovering associations between fading items and existing long-term memories, with discovered associations bubbling up through said bubble-up pathway into the present temporal segment;
whereby the specialized machine operates as a computational substrate for conscious experience in which entry conditions, persistence dynamics, attention sequencing, and temporal properties of the workspace are all continuously recomputed from values of the felt-experience state.
